(19) United States
(12) Patent Application Publication
(10) Pub. No.: US 2025/0008529 A1
(43) Pub. Date: Jan. 2, 2025

(54) METHOD AND DEVICE IN NODES USED FOR WIRELESS COMMUNICATION

(71) Applicants: Qi JIANG, Shanghai (CN); Shulin SONG, Shanghai (CN); Xiaobo ZHANG, Shanghai (CN)

(72) Inventors: Qi JIANG, Shanghai (CN); Shulin SONG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/751,372

(22) Filed: Jun. 24, 2024

(30) Foreign Application Priority Data
Jun. 27, 2023 (CN) 202310769723.7

(51) Int. Cl. H04W 72/232; H04L 5/14; H04W 72/1273

(52) U.S. Cl. CPC H04W 72/232; H04L 5/14; H04W 72/1273

(57) ABSTRACT

A first node receives a first DCI, the first DCI scheduling a first cell set; and receives or transmits a first radio signal in K1 cells of the first cell set; the first DCI indicates a first symbol set, the first radio signal occupying the first symbol set; a first field set in the first DCI is applied to a target cell in the first cell set; an indication of the first field set in the first DCI depends on whether the target cell is configured with at least one first-type symbol, or the indication of the first field set in the first DCI depends on whether the first symbol set comprises at least one first-type symbol; the first-type symbol includes a symbol for uplink that is configured as downlink symbol by TDD UL-DL configuration signaling. This method flexibly adjusts the indication of the field of the DCI.

### CROSS REFERENCE TO RELATED APPLICATIONS

This application claims the priority benefit of Chinese Patent Application No. 202310769723.7, filed on Jun. 27, 2023, the full disclosure of which is incorporated herein by reference.

### BACKGROUND

### Technical Field

The present application relates to transmission methods and devices in wireless communication systems, and in particular to a transmission scheme and device in a wireless communication system.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR. The multi-carrier (including Carrier Aggregation, abbreviated as CA, and Dual Connectivity, abbreviated as DC) techniques is an integral part of New Radio (NR) technology. To adapt to diverse application scenarios and meet different requests, the 3GPP has been working on the evolution of multi-carrier techniques since from the Rel-15.

In existing New Radio (NR) systems, spectrum resources are statically divided into Frequency Division Duplexing (FDD) spectrum and Time Division Duplexing (TDD) spectrum. As for TDD spectrum, both the base station and the UE work in Half Duplex Mode. Such Half Duplex Mode avoids self-interference and reduces the influence of Cross Link interference, but it also brings about a reduction of resource utilization ratio and a longer delay. In view of these problems, supporting flexible duplex mode in TDD spectrum or FDD spectrum becomes a possible solution. The 3GPP Radio Access Network (RAN) 1 #103e meeting agreed on the study item of duplex technology, in which SubBand non-overlapping Full Duplex (SBFD) was proposed, i.e., to support the base station in simultaneously transmitting and receiving on both subbands. Communication in this mode is subject to severe interference, including self-interference and cross-link interference.

### SUMMARY

The inventors have found through researches that how to determine the indication of the fields of DCI (i.e., Downlink Control Information) is a key issue.

To address the above problem, the present application provides a solution. It should be noted that in the description of the present application, multicarrier and flexible duplex modes are only used as two typical application scenarios or examples: the present application is equally applicable to other scenarios facing similar problems (e.g., other scenarios with higher requirements for control channel capacity, including, but not limited to, SBFD, other flexible duplex modes or full-duplex modes, variable link modes, conventional duplex modes, half-duplex mode, energy-efficient scenarios, non-energy-efficient scenarios, capacity-enhanced systems, systems using higher frequencies, coverage-enhanced systems, unlicensed frequency-domain communications, Internet of Things (IoT), Ultra Reliable Low Latency Communication (URLLC) networks, Vehicle-to-Everything, etc.), where similar technical results can be achieved. Besides, using a unified design scheme for different scenarios also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first DCI, the first DCI scheduling a first cell set, the first cell set comprising K1 cells; and
receiving or transmitting a first radio signal in the K1 cells:
herein, the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol; the first-type symbol includes a symbol for uplink that is configured as downlink symbol by TDD UL-DL configuration signaling.

The present application provides a method in a first node for wireless communications, comprising:
receiving a first DCI, the first DCI scheduling a first cell set, the first cell set comprising K1 cells; and
receiving or transmitting a first radio signal in the K1 cells;
herein, the first DCI indicates a first symbol set, the first radio signal occupying the first symbol set in time domain: a first field set in the first DCI is applied to a target cell in the first cell set: an indication of the first field set in the first DCI depends on whether the first symbol set comprises at least one first-type symbol; the first-type symbol includes a symbol for uplink that is configured as downlink symbol by TDD UL-DL configuration signaling.

In one embodiment, a problem to be solved in the present application includes: how to determine the indication of fields of a DCI.

In one embodiment, an advantage of using the above method lies in that it flexibly adjusts the reception and transmission of radio signals by determining the indication of appropriate fields of the DCI.

In one embodiment, an advantage of using the above method lies in that it is applicable to different application scenarios/environments/modes, increasing system flexibility.

In one embodiment, an advantage of using the above method lies in that it supports a flexible duplex mode, which improves uplink coverage and increases the capacity of uplink transmission.

In one embodiment, an advantage of using the above method lies in that it supports multiple serving cells being scheduled with a single DCI at the same time, reducing signaling overhead.

In one embodiment, an advantage of using the above method lies in that it reduces signaling overhead and improves system efficiency while ensuring scheduling flexibility.

According to one aspect of the present application, characterized in that the indication of the first field set in the first DCI depends on whether the target cell is configured with at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

In one embodiment, the above method is characterized in that depending on whether the cell is configured with SBFD mode or not, it flexibly adjusts the interpretation of indication of the DCI's fields, which ensures the reliability of transmission, and improves the capacity of uplink transmission.

According to one aspect of the present application, characterized in that the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

In one embodiment, the above method is characterized in that it adjusts the scheduling of a DCI on multiple cells in a flexible manner according to whether the radio signal occupies SBFD symbols in time domain, which improves the flexibility of the system and increases the capacity of uplink transmission.

According to one aspect of the present application, characterized in that when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset: the first cell subset comprises multiple cells, and the second cell subset comprises multiple cells.

In one embodiment, the above method is characterized in that when multiple serving cells of a same type being simultaneously scheduled by a DCI is realized, an indication is the same for a field in a first field set in a first DCI for the plurality of serving cells: the same type includes being configured with SBFD resources.

In one embodiment, an advantage of using the above method lies in that it reduces signaling overhead.

According to one aspect of the present application, characterized in that the first field set comprises a first field, the first field being a Transmission configuration indication.

In one embodiment, an advantage of using the above method lies in that it flexibly determines spatial Tx/Rx parameters of signals.

According to one aspect of the present application, characterized in that the first field set comprises a second field, the second field being an SRS request.

In one embodiment, an advantage of using the above method lies in that it flexibly triggers transmission of SRS of the UE.

According to one aspect of the present application, characterized in that the first field set comprises a third field, the third field being a PRB bundling size indicator.

In one embodiment, an advantage of using the above method lies in that it flexibly adjusts precoding of signals.

The present application provides a method in a second node for wireless communications, comprising:
transmitting a first DCI, the first DCI scheduling a first cell set, the first cell set comprising K1 cells; and
transmitting or receiving a first radio signal in the K1 cells;
herein, the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol; the first-type symbol includes a symbol for uplink that is configured as downlink symbol by TDD UL-DL configuration signaling.

The present application provides a method in a second node for wireless communications, comprising:
transmitting a first DCI, the first DCI scheduling a first cell set, the first cell set comprising K1 cells; and
transmitting or receiving a first radio signal in the K1 cells;
herein, the first DCI indicates a first symbol set, the first radio signal occupying the first symbol set in time domain: a first field set in the first DCI is applied to a target cell in the first cell set: an indication of the first field set in the first DCI depends on whether the first symbol set comprises at least one first-type symbol; the first-type symbol includes a symbol for uplink that is configured as downlink symbol by TDD UL-DL configuration signaling.

According to one aspect of the present application, characterized in that the indication of the first field set in the first DCI depends on whether the target cell is configured with at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

According to one aspect of the present application, characterized in that the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

According to one aspect of the present application, characterized in that when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset: the first cell subset comprises multiple cells, and the second cell subset comprises multiple cells.

According to one aspect of the present application, characterized in that the first field set comprises a first field, the first field being a Transmission configuration indication.

According to one aspect of the present application, characterized in that the first field set comprises a second field, the second field being an SRS request.

According to one aspect of the present application, characterized in that the first field set comprises a third field, the third field being a PRB bundling size indicator.

The present application provides a first node for wireless communications, comprising:
a first receiver, receiving a first DCI, the first DCI scheduling a first cell set, the first cell set comprising K1 cells; and
a first transceiver, receiving or transmitting a first radio signal in the K1 cells;
herein, the first DCI indicates a first symbol set, the first radio signal occupying the first symbol set in time domain; a first field set in the first DCI is applied to a target cell in the first cell set; an indication of the first field set in the first DCI depends on whether the target cell is configured with at least one first-type symbol; the first-type symbol includes a symbol for uplink that is configured as downlink symbol by TDD UL-DL configuration signaling.

The present application provides a first node for wireless communications, comprising:
a first receiver, receiving a first DCI, the first DCI scheduling a first cell set, the first cell set comprising K1 cells; and
a first transceiver, receiving or transmitting a first radio signal in the K1 cells;
herein, the first DCI indicates a first symbol set, the first radio signal occupying the first symbol set in time domain; a first field set in the first DCI is applied to a target cell in the first cell set; an indication of the first field set in the first DCI depends on whether the first symbol set comprises at least one first-type symbol; the first-type symbol includes a symbol for uplink that is configured as downlink symbol by TDD UL-DL configuration signaling.

The present application provides a second node for wireless communications, comprising:
a second transmitter, transmitting a first DCI, the first DCI scheduling a first cell set, the first cell set comprising K1 cells; and
a second transceiver, transmitting or receiving a first radio signal in the K1 cells;
herein, the first DCI indicates a first symbol set, the first radio signal occupying the first symbol set in time domain; a first field set in the first DCI is applied to a target cell in the first cell set: an indication of the first field set in the first DCI depends on whether the target cell is configured with at least one first-type symbol; the first-type symbol includes a symbol for uplink that is configured as downlink symbol by TDD UL-DL configuration signaling.

The present application provides a second node for wireless communications, comprising:
a second transmitter, transmitting a first DCI, the first DCI scheduling a first cell set, the first cell set comprising K1 cells; and
a second transceiver, transmitting or receiving a first radio signal in the K1 cells;
herein, the first DCI indicates a first symbol set, the first radio signal occupying the first symbol set in time domain; a first field set in the first DCI is applied to a target cell in the first cell set; an indication of the first field set in the first DCI depends on whether the first symbol set comprises at least one first-type symbol; the first-type symbol includes a symbol for uplink that is configured as downlink symbol by TDD UL-DL configuration signaling.

In one embodiment, compared with the prior art, the present application is advantageous in the following aspects:
flexible adjustment of the indication of the fields of the DCI;
applicable to different application scenarios/environments/modes, increasing system flexibility;
reduced signaling overhead;
increased system reliability;
increased transmission capacity;
improved system performance.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first DCI and a first radio signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of wireless transmission according to one embodiment of the present application.

FIG. 6 illustrates a flowchart of wireless transmission according to another embodiment of the present application.

FIG. 7 illustrates a schematic diagram of an indication of a first field set according to one embodiment of the present application.

FIG. 8 illustrates a schematic diagram of an indication of a first field set according to another embodiment of the present application.

FIG. 9 illustrates a schematic diagram of relations among a target cell, a first cell subset and a second cell subset according to one embodiment of the present application.

FIG. 10 illustrates a schematic diagram of fields included in a first field set according to one embodiment of the present application.

FIG. 11 illustrates a schematic diagram of fields included in a first field set according to another embodiment of the present application.

FIG. 12 illustrates a schematic diagram of fields included in a first field set according to a third embodiment of the present application.

FIG. 13 illustrates a structure block diagram of a processing device in a first node according to one embodiment of the present application.

FIG. 14 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

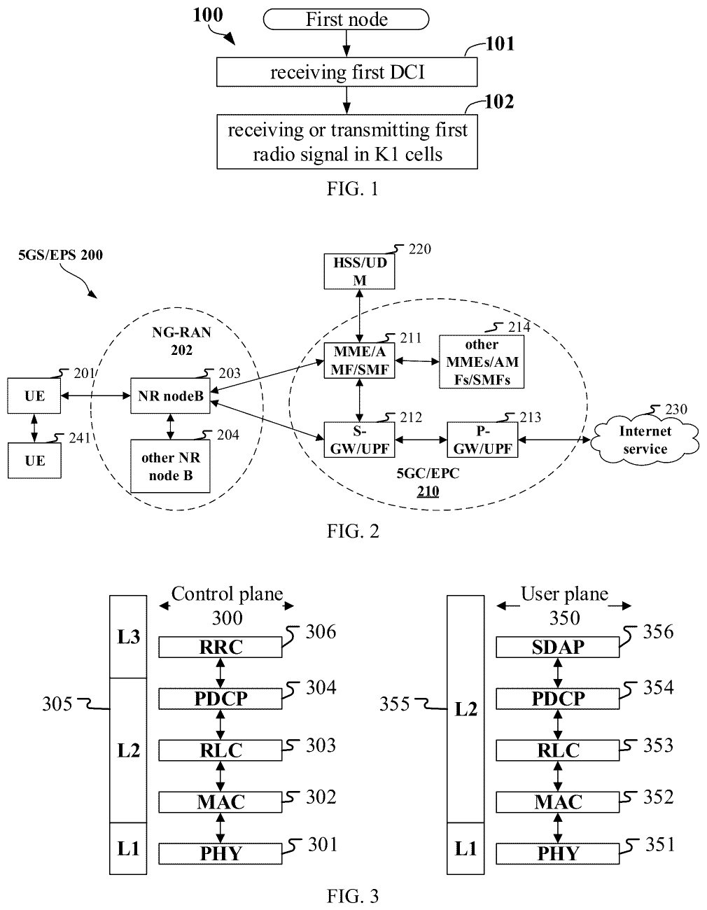

Embodiment 1 illustrates a flowchart of a first DCI and a first radio signal according to one embodiment of the present application, as shown in FIG. 1. In 100 illustrated by FIG. 1, each box represents a step.

In Embodiment 1, the first node in this application receives a first DCI in step 101, the first DCI scheduling a first cell set, the first cell set comprising K1 cells; and receives or transmits a first radio signal in the K1 cells in step 102: herein the first DCI indicates a first symbol set, the first radio signal occupying the first symbol set in time domain: a first field set in the first DCI is applied to a target cell in the first cell set; an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the DCI refers to Downlink control information.

In one embodiment, the first DCI is a DCI format.

In one embodiment, the first DCI comprises at least one field in a DCI format.

In one embodiment, the first DCI is UE group common.

In one embodiment, the first DCI is UE group specific.

In one embodiment, the first DCI is UE specific.

In one embodiment, the first DCI is a downlink DCI.

In one embodiment, the first DCI is an uplink DCI.

In one embodiment, the first DCI is a Non-fallback DCI.

In one embodiment, the first DCI is monitored in a UE-specific Search Space (USS) set.

In one embodiment, the format of the first DCI is format 0_X.

In one embodiment, the format of the first DCI is format 1_X.

In one embodiment, the format of the first DCI is format 0_X or 1_X.

In one subembodiment, X is a positive integer greater than 2.

In one embodiment, the format of the first DCI is format 0_3.

In one embodiment, the format of the first DCI is format 1_3.

In one embodiment, the format of the first DCI is format 0_3 or 1_3.

In one embodiment, the format of the first DCI is format 0_4.

In one embodiment, the format of the first DCI is format 1_4.

In one embodiment, the format of the first DCI is format 0_4 or 1_4.

In one embodiment, the first DCI schedules a first cell set, and scheduling information included in the first DCI includes one or more of time-domain resources, frequency-domain resources, a Modulation and coding scheme (MCS), a DMRS port, a HARQ process number, a Redundancy version (RV), a New Data Indicator (NDI), a TCI state, a Sounding reference signal indicator (SRI), or precoding being employed.

In one embodiment, the cell in the present application includes a serving cell.

In one embodiment, the cell in the present application includes a physical cell.

In one embodiment, the cell in the present application includes a Component Carrier (CC).

In one embodiment, the cell in the present application includes a Primary Cell (PCell).

In one embodiment, the cell in the present application includes a Secondary Cell (SCell).

In one embodiment, the cell in the present application includes a Special Cell (SpCell).

In one embodiment, the cell in the present application is a serving cell of the first node.

In one embodiment, the cell in the present application is assigned with a SCellIndex or a ServCellIndex.

In one embodiment, the first cell set comprises multiple cells.

In one embodiment, the first cell set comprises only multiple serving cells.

In one embodiment, cells included in the first cell set belong to a same cell group.

In one embodiment, cells included in the first cell set all belong to a Master Cell Group (MCG) or all belong to a Secondary Cell Group (SCG).

In one embodiment, cells included in the first cell set belong to a same Physical Uplink Control Channel (PUCCH) group.

In one embodiment, a PUCCH group comprises a group of cells, where a PUCCH signaling of the group of cells is associated with a PUCCH of a SpCell, or where a PUCCH signaling of the group of cells is associated with a PUCCH of a PUCCH SCell; the PUCCH SCell is a SCell configured with a PUCCH.

In one embodiment, a PUCCH group comprises a group of cells, a PUCCH signaling of the group of cells being associated with a PUCCH of the same cell.

In one embodiment, cells included in the first cell set have the same numerology.

In one embodiment, cells included in the first cell set have the same Subcarrier spacing configuration.

In one embodiment, there are two cells in the first cell set having different Subcarrier spacing configurations.

In one embodiment, Active BWPs configured for the cells included in the first cell set have the same numerology.

In one embodiment, Active BWPs configured for the cells included in the first cell set have the same Subcarrier spacing configuration.

In one embodiment, there are two cells in the first cell set for which the Active BWPs configured have different Subcarrier spacing configurations.

In one embodiment, the first DCI is used to determine the first cell set.

In one embodiment, the first DCI is used to determine cells included in the first cell set.

In one embodiment, the first DCI is used to indicate the first cell set.

In one embodiment, the first DCI is used to indicate cells included in the first cell set.

In one embodiment, the first cell set indicated by the first DCI is identified by a n_CI.

In one embodiment, the name of a field indicating a cell included in the first cell set includes FDRA

(i.e., Frequency domain resource assignment).

In one embodiment, a field indicating a cell included in the first cell set comprises multiple FDRA fields.

In one embodiment, the name of a field indicating a cell included in the first cell set includes CIF (i.e., Carrier Indicator Field).

In one embodiment, the first DCI comprises a fourth field, the fourth field of the first DCI being used to indicate cells included in the first cell set.

In one embodiment, the fourth field of the first DCI comprises at least one DCI field.

In one embodiment, the fourth field of the first DCI is a DCI field.

In one embodiment, the fourth field of the first DCI comprises multiple DCI fields.

In one embodiment, the fourth field of the first DCI is used to indicate the first cell set from M1 candidate cell sets, and candidates for the first cell set include the M1 candidate cell sets, M1 being a positive integer greater than 1.

In one subembodiment, the value of M1 is used to determine a maximum number of information bits occupied by the fourth field of the first DCI.

In one subembodiment, the maximum number of information bits occupied by the fourth field of the first DCI is equal to [log₂(M1)].

In one subembodiment, the maximum number of information bits occupied by the fourth field of the first DCI is equal to [log₂(M1)]+1.

In one embodiment, the fourth field of the first DCI includes a Carrier Indicator Field (CIF).

In one embodiment, the fourth field of the first DCI is used to indicate cells included in the first cell set.

In one embodiment, the fourth field of the first DCI is used to determine cells included in the first cell set.

In one embodiment, the fourth field of the first DCI is used to indicate cell indexes of the cells included in the first cell set.

In one embodiment, the cell index includes one or more of a PhysCellId, a SCellIndex or a ServCellIndex.

In one embodiment, the cell index includes a Physical Cell Identity (PCI).

In one embodiment, the cell index includes a ServCellIndex.

In one embodiment, the cell index includes a schedulingCellId.

In one embodiment, a physical layer channel occupied by the first radio signal includes a Physical Uplink Shared Channel (PUSCH).

In one embodiment, a physical layer channel occupied by the first radio signal includes a Physical Downlink Shared Channel (PDSCH).

In one embodiment, a physical layer channel occupied by the first radio signal includes a Physical Uplink Shared Channel (PUSCH) or a Physical Downlink Shared Channel (PDSCH).

In one embodiment, the first signal is transmitted on an uplink physical control channel (i.e., an uplink channel only capable of carrying physical layer control signaling).

In one embodiment, a physical layer channel occupied by the first radio signal includes a Physical Uplink Control Channel (PUCCH).

In one embodiment, a physical layer channel occupied by the first radio signal includes a Physical Downlink Control Channel (PDCCH).

In one embodiment, based on the scheduling of the first DCI, the first node transmits at least one PUSCH on each cell of the K1 cells.

In one embodiment, based on the scheduling of the first DCI, the first node performs signal transmission in at least one PUSCH on each cell of the K1 cells.

In one embodiment, based on the scheduling of the first DCI, the first node transmits in one PUSCH on each cell of the K1 cells at least one of Transport Block(s) (TB(s)) or a Channel state information (CSI) report.

In one embodiment, based on the scheduling of the first DCI, the first node transmits at least one PDSCH on each cell of the K1 cells.

In one embodiment, based on the scheduling of the first DCI, the first node performs signal reception in at least one PDSCH on each cell of the K1 cells.

In one embodiment, based on the scheduling of the first DCI, the first node receives Transport Block(s) (TB(s)) in one PDSCH on each cell of the K1 cells.

In one embodiment, a first radio signal received or transmitted in the K1 cells occupies the same time-domain resources.

In one embodiment, a first radio signal received or transmitted in the K1 cells occupies different time-domain resources.

In one embodiment, a first radio signal received or transmitted in the K1 cells occupies the same time-domain resources and the time-domain resources correspond to different frequency-domain resources.

In one embodiment, the first symbol set is configured by RRC signaling.

In one embodiment, an RRC signaling configuring the first symbol set comprises a PDSCH-Config IE.

In one embodiment, an RRC signaling configuring the first symbol set comprises a PDSCH-ConfigCommon IE.

In one embodiment, an RRC signaling configuring the first symbol set comprises a pdsch-TimeDomainAllocationList field in a PDSCH-Config IE.

In one embodiment, an RRC signaling configuring the first symbol set comprises a pdsch-TimeDomainAllocationList field in a PDSCH-ConfigCommon IE.

In one embodiment, an RRC signaling configuring the first symbol set comprises a PUSCH-Config IE.

In one embodiment, an RRC signaling configuring the first symbol set comprises a PUSCH-ConfigCommon IE.

In one embodiment, an RRC signaling configuring the first symbol set comprises a pusch-TimeDomainAllocationList field in a PUSCH-Config IE.

In one embodiment, an RRC signaling configuring the first symbol set comprises a pusch-TimeDomainAllocationList field in a PUSCH-ConfigCommon IE.

In one embodiment, a Time Domain Resource Assignment (TDRA) field of the first DCI indicates the first symbol set.

In one embodiment, a Time Domain Resource Assignment (TDRA) field of the first DCI indicates a start symbol and a length of the first symbol set.

In one embodiment, a Time Domain Resource Assignment (TDRA) field of the first DCI indicates a start position of the first symbol set and a number of symbols included in the first symbol set.

In one embodiment, a Time Domain Resource Assignment (TDRA) field of the first DCI indicates a mapping type of the first symbol set.

In one embodiment, the first symbol set comprises a positive integer number of symbol(s).

In one embodiment, the first symbol set comprises one or more symbols.

In one embodiment, the first symbol set comprises one symbol.

In one embodiment, the first symbol set comprises multiple symbols.

In one embodiment, the first symbol set comprises multiple slots.

In one embodiment, the symbol is a single-carrier symbol.

In one embodiment, the symbol is a multi-carrier symbol.

In one embodiment, “the first radio signal occupying the first symbol set in time domain” means that the first symbol set is a time-domain resource for transmitting the first radio signal.

In one embodiment, “the first radio signal occupying the first symbol set in time domain” means that the first symbol set is configured to the first node for transmitting the first radio signal.

In one embodiment, “the first radio signal occupying the first symbol set in time domain” means that the first symbol set is indicated to the first node for transmitting the first radio signal.

In one embodiment, “the first radio signal occupying the first symbol set in time domain” means that all of the symbols included in the first symbol set are used for the transmission of the first radio signal.

In one embodiment, “the first radio signal occupying the first symbol set in time domain” means that each of the symbols included in the first symbol set is used for the transmission of the first radio signal.

In one embodiment, “the first radio signal occupying the first symbol set in time domain” means that the first symbol set includes all of the symbols used for the transmission of the first radio signal.

In one embodiment, the first field set in the first DCI comprises only one field.

In one embodiment, the first field set in the first DCI comprises multiple fields.

In one embodiment, a field of the first field set in the first DCI comprises at least one bit.

In one embodiment, a field of the first field set in the first DCI comprises a non-negative integer number of bits.

In one embodiment, the first field set in the first DCI comprises all fields in the first DCI.

In one embodiment, the first field set in the first DCI comprises only a portion of the fields in the first DCI.

In one embodiment, any field of the first field set in the first DCI is used for at least one cell in the first cell set.

In one embodiment, any field of the first field set in the first DCI is used for the target cell in the first cell set.

In one embodiment, the first field set in the first DCI comprises a Time Domain Resource Assignment (TDRA) field.

In one embodiment, the first field set in the first DCI comprises a VRB-to-PRB mapping field.

In one embodiment, the first field set in the first DCI comprises an Antenna port(s) field.

In one embodiment, the first field set in the first DCI comprises a DMRS sequence initialization field.

In one embodiment, the first field set in the first DCI comprises a Priority indicator field.

In one embodiment, the first field set in the first DCI comprises a PRB bundling size indicator field.

In one embodiment, the first field set in the first DCI comprises an Enhanced Type 3 codebook indicator field.

In one embodiment, the first field set in the first DCI comprises a HARQ-ACK retransmission indicator field.

In one embodiment, the first field set in the first DCI comprises a PUCCH Cell indicator field.

In one embodiment, the first field set in the first DCI comprises a Frequency hopping flag field.

In one embodiment, the first field set in the first DCI comprises an SRS resource indicator field.

In one embodiment, the first field set in the first DCI comprises a beta_offset indicator field.

In one embodiment, the first field set in the first DCI comprises a Bandwidth part indicator field.

In one embodiment, the first field set in the first DCI comprises a ChannelAccess-Cpext field.

In one embodiment, the first field set in the first DCI comprises a ChannelAccess-CPext-CAPC field.

In one embodiment, the first field set in the first DCI comprises a field of Precoding information and number of layers.

In one embodiment, the first field set in the first DCI comprises a field of Open-loop power control parameter set indication.

In one embodiment, the first field set in the first DCI comprises an SRS request field.

In one embodiment, the first field set in the first DCI comprises an SRS offset indicator field.

In one embodiment, the first field set in the first DCI comprises a Rate matching indicator field.

In one embodiment, the first field set in the first DCI comprises a ZP CSI-RS trigger field.

In one embodiment, the first field set in the first DCI comprises a Transmission configuration indication field.

In one embodiment, the first field set in the first DCI comprises a TPC command for scheduled PUCCH field.

In one embodiment, the first field set in the first DCI comprises a PDSCH-to-HARQ_feedback timing indicator field.

In one embodiment, the first field set in the first DCI comprises a Downlink assignment index field.

In one embodiment, the first field set in the first DCI comprises a PUCCH resource indicator field.

In one embodiment, the first field set in the first DCI comprises a One-shot HARQ-ACK request field.

In one embodiment, a transmitter of the first DCI receives and transmits radio signals simultaneously on the first-type symbols.

In one embodiment, a transmitter of the first DCI performs uplink and downlink transmissions simultaneously on the first-type symbols.

In one embodiment, a transmitter of the first DCI receives radio signals on frequency-domain resources included in a first sub-band of the first-type symbols and transmits radio signals on frequency-domain resources outside of the first sub-band of the first-type symbols.

In one embodiment, a transmitter of the first DCI performs uplink transmissions on frequency-domain resources included in a first sub-band of the first-type symbols, and performs downlink transmissions on frequency-domain resources outside of the first sub-band of the first-type symbols.

In one embodiment, the first sub-band occupies at least one Resource Block set (RB set) in frequency domain.

In one subembodiment, the one RB set is a set of contiguous RB(s).

In one subembodiment, the RB set is configured by a higher layer parameter IntraCellGuardBandsPerSCS.

In one subembodiment, the RB set is configured by a higher layer parameter intraCellGuardBandsUL-List.

In one subembodiment, a guard band exists between two neighboring RB sets.

In one embodiment, there exist guard bands at both ends of the first sub-band in frequency domain.

In one subembodiment, the guard band is not used for uplink transmission or downlink transmission.

In one embodiment, the first sub-band occupies at least one RB(s) in frequency domain.

In one subembodiment, the at least one RB(s) includes one RB.

In one subembodiment, the at least one RB(s) includes multiple consecutive RBs.

In one embodiment, the RB in the present application includes Physical RB (PRB).

In one embodiment, the RB in the present application includes Virtual RB (VRB).

In one embodiment, the first sub-band occupies multiple subcarriers in frequency domain.

In one embodiment, the first sub-band occupies multiple consecutive subcarriers in frequency domain.

In one embodiment, the first sub-band belongs to a UL carrier.

In one embodiment, frequency-domain resources occupied by the first sub-band belong to one UL carrier.

In one embodiment, the UL carrier in this application comprises a Normal Uplink (NUL) carrier.

In one embodiment, the UL carrier in the present application comprises a Supplementary UL (SUL) carrier.

In one embodiment, the first sub-band belongs to a DL carrier.

In one embodiment, frequency-domain resources occupied by the first sub-band belong to a DL carrier.

In one embodiment, the first sub-band belongs to a BandWidth Part (BWP).

In one embodiment, the first sub-band belongs to a UL BWP.

In one embodiment, frequency-domain resources occupied by the first sub-band belong to a UL BWP.

In one embodiment, the first sub-band belongs to a DL BWP.

In one embodiment, frequency-domain resources occupied by the first sub-band belong to a DL BWP.

In one embodiment, there is overlapping frequency-domain resource between the first sub-band and a UL BWP.

In one embodiment, there is no overlapping frequency-domain resource between the first sub-band and a UL BWP.

In one embodiment, the first sub-band comprises a SubBand non-overlapping Full Duplex (SBFD) subband.

In one embodiment, the first sub-band is an SBFD subband.

In one embodiment, the frequency-domain resources occupied by the first sub-band comprise frequency-domain resources occupied by one SBFD subband.

In one embodiment, the frequency-domain resources occupied by the first sub-band are overlapped with frequency-domain resources occupied by one SBFD subband.

In one embodiment, the frequency-domain resources occupied by the first sub-band comprise some or all of frequency-domain resources occupied by one SBFD subband.

In one embodiment, the frequency-domain resources occupied by the first sub-band comprise frequency-domain resources other than the frequency-domain resources occupied by one SBFD subband.

In one embodiment, the one SBFD subband in this application is used for uplink transmission.

In one embodiment, the one SBFD subband in this application can be used for uplink transmission.

In one embodiment, the one SBFD subband in this application is a UL subband.

In one embodiment, the first sub-band is configured via RRC signaling.

In one embodiment, the first sub-band is configured via Cell-common RRC signaling.

In one embodiment, the first sub-band is configured via UE group-common RRC signaling.

In one embodiment, the first sub-band is configured through a MAC CE.

In one embodiment, the first sub-band is configured via physical layer signaling.

In one embodiment, the first sub-band is configured via DCI signaling.

In one embodiment, the first-type symbols include a downlink symbol for uplink transmission that is indicated by TDD uplink-downlink (UL-DL) configuration.

In one embodiment, the first-type symbols are downlink symbols for uplink transmission that are indicated by TDD uplink-downlink (UL-DL) configuration.

In one embodiment, the first-type symbols include a downlink symbol that can be used for uplink transmission that is indicated by TDD uplink-downlink (UL-DL) configuration.

In one embodiment, the first-type symbols are downlink symbols that can be used for uplink transmission that are indicated by TDD uplink-downlink (UL-DL) configuration.

In one embodiment, the first-type symbols also include a flexible symbol for uplink transmission that is indicated by TDD uplink-downlink (UL-DL) configuration.

In one embodiment, the first-type symbols are flexible symbols for uplink transmission that are indicated by TDD uplink-downlink (UL-DL) configuration.

In one embodiment, the first-type symbols also include a flexible symbol that can be used for uplink transmission that is indicated by TDD uplink-downlink (UL-DL) configuration.

In one embodiment, the first-type symbols are flexible symbols that can be used for uplink transmission that are indicated by TDD uplink-downlink (UL-DL) configuration.

In one embodiment, the first-type symbols include a downlink symbol for uplink transmission that is indicated by TDD uplink-downlink (UL-DL) configuration and a flexible symbol for uplink transmission that is indicated by TDD UL-DL configuration.

In one embodiment, the first-type symbols include a downlink symbol that can be used for uplink transmission that is indicated by TDD uplink-downlink (UL-DL) configuration and a flexible symbol that can be used for uplink transmission that is indicated by TDD UL-DL configuration.

In one embodiment, the TDD uplink-downlink configuration includes all or part of fields in a TDD-UL-DL-ConfigCommon IE.

In one embodiment, the TDD uplink-downlink configuration includes all or part of fields in a TDD-UL-DL-ConfigDedicated IE.

In one embodiment, the TDD uplink-downlink configuration includes all or part of fields in a ServingCellConfig IE.

In one embodiment, the TDD uplink-downlink configuration includes all or part of fields in a Serving CellConfigCommonSIB IE.

In one embodiment, the TDD uplink-downlink configuration includes information of all or part of fields in a ServingCellConfigCommon IE.

In one embodiment, the first-type symbol is a SBFD symbol.

In one embodiment, the first-type symbol is a full duplex symbol.

In one embodiment, the first-type symbol is a symbol that is used for both transmission and reception.

In one embodiment, the first-type symbol is a symbol that supports simultaneous uplink transmission and downlink transmission.

In one embodiment, the first-type symbols include a positive integer number of symbol(s).

In one embodiment, the first-type symbols include one or more symbols.

In one embodiment, the first-type symbols include one symbol.

In one embodiment, the first-type symbols include multiple symbols.

In one embodiment, the first-type symbols include at least one slot.

In one embodiment, the first-type symbols include at least one subframe.

In one embodiment, the symbol is a single-carrier symbol.

In one embodiment, the symbol is a multi-carrier symbol.

In one embodiment, the multicarrier symbol is an Orthogonal Frequency Division Multiplexing (OFDM) Symbol.

In one embodiment, the symbol is obtained by an output by transform precoding through OFDM Symbol Generation.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multi Carrier (FBMC) symbol.

In one embodiment, the multicarrier symbol comprises a Cyclic Prefix (CP).

In one embodiment, the first-type symbols include symbols that are used for both uplink transmission and downlink transmission.

In one embodiment, any one of the first-type symbols can be used for both uplink transmission and downlink transmission.

In one embodiment, any one of the first-type symbols is used for both uplink transmission and downlink transmission.

In one embodiment, at least one of the first-type symbols is used for both uplink transmission and downlink transmission.

In one embodiment, the first-type symbols do not include symbols used for transmission of first-type downlink signals, the first-type downlink signals comprising one or more of a Synchronisation Signal (SS)/physical broadcast channel (PBCH) Block, a COntrol REsource SET (CORESET) with index 0, or a System Information Block (SIB).

In one embodiment, the first-type symbols are configured by higher layer signaling.

In one embodiment, the signaling configuring the first-type symbols includes an RRC signaling.

In one embodiment, the signaling configuring the first-type symbols includes a MAC CE.

In one embodiment, the signaling configuring the first-type symbols includes a physical layer signaling.

In one embodiment, the signaling configuring the first-type symbols includes a DCI.

In one embodiment, the target cell is a serving cell.

In one embodiment, the target cell is a cell.

In one embodiment, the target cell corresponds to a Component Carrier (CC).

In one embodiment, the target cell corresponds to a Physical Cell Identity (PCI).

In one embodiment, the target cell corresponds to a ServCellIndex.

In one embodiment, the target cell corresponds to a schedulingCellId.

In one embodiment, the target cell corresponds to a Carrier Indicator Field (CIF).

In one embodiment, “a first field set in the first DCI is applied to a target cell in the first cell set” means that the first field set in the first DCI comprises scheduling information for a PUSCH transmitted on the target cell.

In one embodiment, “a first field set in the first DCI is applied to a target cell in the first cell set” means that the first field set in the first DCI comprises indicative information related to a PUSCH transmitted on the target cell.

In one embodiment, “a first field set in the first DCI is applied to a target cell in the first cell set” means that the first field set in the first DCI comprises indicative information used for transmission of a PUSCH on the target cell.

In one embodiment, “a first field set in the first DCI is applied to a target cell in the first cell set” means that the first field set in the first DCI comprises scheduling information for a PDSCH transmitted on the target cell.

In one embodiment, “a first field set in the first DCI is applied to a target cell in the first cell set” means that the first field set in the first DCI comprises indicative information related to a PDSCH transmitted on the target cell.

In one embodiment, “a first field set in the first DCI is applied to a target cell in the first cell set” means that the first field set in the first DCI comprises indicative information used for reception of a PDSCH on the target cell.

In one embodiment, “a first field set in the first DCI is applied to a target cell in the first cell set” means that the first field set in the first DCI comprises indicative information used for a signal transmitted on the target cell.

In one embodiment, “a first field set in the first DCI is applied to a target cell in the first cell set” means that each field of the first field set in the first DCI comprises indicative information for the target cell.

In one embodiment, “a first field set in the first DCI is applied to a target cell in the first cell set” means that at least one field of the first field set in the first DCI comprises indicative information for the target cell.

In one embodiment, “a first field set in the first DCI is applied to a target cell in the first cell set” means that each field of the first field set in the first DCI comprises indicative information for a PUSCH transmitted on the target cell.

In one embodiment, “a first field set in the first DCI is applied to a target cell in the first cell set” means that each field of the first field set in the first DCI comprises indicative information for a PDSCH received on the target cell.

In one embodiment, “a first field set in the first DCI is applied to a target cell in the first cell set” means that each field of the first field set in the first DCI comprises indicative information for a signal transmitted on the target cell.

In one embodiment, the indication of the first field set in the first DCI includes: an indication of at least one field of the first field set in the first DCI for time-domain resources.

In one embodiment, the indication of the first field set in the first DCI includes: an indication of at least one field of the first field set in the first DCI for a start symbol and length of time-domain resources.

In one embodiment, the indication of the first field set in the first DCI includes: an indication of at least one field of the first field set in the first DCI for a mapping type of time-domain resources.

In one embodiment, the indication of the first field set in the first DCI includes: an indication of at least one field of the first field set in the first DCI for an interleaved manner.

In one embodiment, the indication of the first field set in the first DCI includes: an indication of at least one field of the first field set in the first DCI for Antenna ports.

In one embodiment, the indication of the first field set in the first DCI includes: an indication of at least one field of the first field set in the first DCI for information about DMRS sequence generation.

In one embodiment, the indication of the first field set in the first DCI includes: an indication of at least one field of the first field set in the first DCI for priority.

In one embodiment, the indication of the first field set in the first DCI includes: an indication of at least one field of the first field set in the first DCI for a PRB bundling manner.

In one embodiment, the indication of the first field set in the first DCI includes: an indication of at least one field of the first field set in the first DCI for a PRB bundling size.

In one embodiment, the indication of the first field set in the first DCI includes: an indication of at least one field of the first field set in the first DCI for Type3 HARQ feedback.

In one embodiment, the indication of the first field set in the first DCI includes: an indication of at least one field of the first field set in the first DCI for dynamic switching of PUCCH.

In one embodiment, the indication of the first field set in the first DCI includes: an indication of at least one field of the first field set in the first DCI for frequency hopping or not.

In one embodiment, the indication of the first field set in the first DCI includes: an indication of at least one field of the first field set in the first DCI for frequency hopping offset(s).

In one embodiment, the indication of the first field set in the first DCI includes: an indication of at least one field of the first field set in the first DCI for SRS resources.

In one embodiment, the indication of the first field set in the first DCI includes: an indication of at least one field of the first field set in the first DCI for a set of SRS resources.

In one embodiment, the indication of the first field set in the first DCI includes: an indication of at least one field of the first field set in the first DCI for a value of beta_offset.

In one embodiment, the indication of the first field set in the first DCI includes: an indication of at least one field of the first field set in the first DCI for BWP Switch.

In one embodiment, the indication of the first field set in the first DCI includes: an indication of at least one field of the first field set in the first DCI for the Cyclic prefix spread of signals, as well as the priority classes of channel access.

In one embodiment, the indication of the first field set in the first DCI includes: an indication of at least one field of the first field set in the first DCI for at least one of pre-coding information or a number of transmission layers.

In one embodiment, the indication of the first field set in the first DCI includes: an indication of at least one field of the first field set in the first DCI for parameters related to power control of PUSCH.

In one embodiment, the indication of the first field set in the first DCI includes: an indication of at least one field of the first field set in the first DCI for Open-loop power control parameters of PUSCH.

In one embodiment, the indication of the first field set in the first DCI includes: an indication of at least one field of the first field set in the first DCI for triggering of aperiodic SRS resources.

In one embodiment, the indication of the first field set in the first DCI includes: an indication of at least one field of the first field set in the first DCI for transmitting SRS resources.

In one embodiment, the indication of the first field set in the first DCI includes: an indication of at least one field of the first field set in the first DCI for Rate Match Pattern.

In one embodiment, the indication of the first field set in the first DCI includes: an indication of at least one field of the first field set in the first DCI for aperiodic ZP CSI-RS resources.

In one embodiment, the indication of the first field set in the first DCI includes: an indication of at least one field of the first field set in the first DCI for Spatial Rx parameters.

In one embodiment, the indication of the first field set in the first DCI includes: an indication of at least one field of the first field set in the first DCI for Spatial parameters.

In one embodiment, the indication of the first field set in the first DCI includes: an indication of at least one field of the first field set in the first DCI for transmission configuration.

In one embodiment, the indication of the first field set in the first DCI includes: an indication of at least one field of the first field set in the first DCI for transmitting power of PUCCH.

In one embodiment, the indication of the first field set in the first DCI includes: an indication of at least one field of the first field set in the first DCI for PUCCH resources.

In one embodiment, the indication of the first field set in the first DCI includes: an indication of at least one field of the first field set in the first DCI for a slot offset of PDSCH to HARQ.

In one embodiment, the indication of the first field set in the first DCI includes: an indication of at least one field of the first field set in the first DCI for One-shot HARQ-ACK Request.

In one embodiment, the indication of the first field set in the first DCI includes: an indication of at least one field of the first field set in the first DCI for Downlink assignment index.

In one embodiment, “an indication of the first field set in the first DCI depends on whether the target cell is configured with at least one first-type symbol” means that an indication of each field of the first field set in the first DCI is dependent on whether the target cell is configured with at least one of the first-type symbols.

In one embodiment, “an indication of the first field set in the first DCI depends on whether the target cell is configured with at least one first-type symbol” means that an indication of all fields of the first field set in the first DCI is dependent on whether the target cell is configured with at least one of the first-type symbols.

In one embodiment, “an indication of the first field set in the first DCI depends on whether the target cell is configured with at least one first-type symbol” means that an indication of any field of the first field set in the first DCI is dependent on whether the target cell is configured with at least one of the first-type symbols.

In one embodiment, “an indication of the first field set in the first DCI depends on whether the target cell is configured with at least one first-type symbol” means that an indication of at least one field of the first field set in the first DCI is dependent on whether the target cell is configured with at least one of the first-type symbols.

In one embodiment, “the indication of the first field set in the first DCI depends on whether the first symbol set comprises at least one first-type symbol” means that an indication of each field of the first field set in the first DCI is dependent on whether the first symbol set comprises at least one first-type symbol.

In one embodiment, “the indication of the first field set in the first DCI depends on whether the first symbol set comprises at least one first-type symbol” means that an indication of all fields of the first field set in the first DCI is dependent on whether the first symbol set comprises at least one first-type symbol.

In one embodiment, “the indication of the first field set in the first DCI depends on whether the first symbol set comprises at least one first-type symbol” means that an indication of any field of the first field set in the first DCI is dependent on whether the first symbol set comprises at least one first-type symbol.

In one embodiment, “the indication of the first field set in the first DCI depends on whether the first symbol set comprises at least one first-type symbol” means that an indication of at least one field of the first field set in the first DCI is dependent on whether the first symbol set comprises at least one first-type symbol.

In one embodiment, “the indication of the first field set in the first DCI depends on whether the first symbol set comprises at least one first-type symbol” means that an indication of the first field set in the first DCI is dependent on whether the first symbol set overlaps with the first-type symbols.

In one embodiment, “the indication of the first field set in the first DCI depends on whether the first symbol set comprises at least one first-type symbol” means that an indication of the first field set in the first DCI is dependent on whether the first symbol set includes the first-type symbols.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The network architecture 200 of the LTE, LTE-A and future 5G systems may be called an Evolved Packet System (EPS) 200. The 5G NR or LTE network architecture 200 may be called a 5G System/Evolved Packet System (5GS/EPS) 200 or other suitable terminology. The 5GS/EPS 200 may comprise one or more UEs 201, a UE 241 in sidelink communication with the UE(s) 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS200 may be interconnected with other access networks. For simple description, the entities/interfaces are not shown. As shown in FIG. 2, the 5GS/EPS200 provides packet switching services. Those skilled in the art will find it easy to understand that various concepts presented throughout the present application can be extended to networks providing circuit switching services. The NG-RAN202 includes NR (New Radio) Node B (gNB) 203 and other gNB204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the first node in the present application includes the UE 241.

In one embodiment, the second node in the present application includes the gNB203.

In one embodiment, the UE201 supports multiple carriers being scheduled by a same DCI.

In one embodiment, the UE201 supports multiple serving cells being scheduled by a same DCI.

In one embodiment, the UE 201 supports cross-carrier scheduling.

In one embodiment, the NR node B corresponds to the second node in the present application.

In one embodiment, the NR node B supports multiple carriers being scheduled by a same DCI.

In one embodiment, the NR node B supports multiple serving cells being scheduled by a same DCI.

In one embodiment, the NR node B supports cross-carrier scheduling.

In one embodiment, the NR node B is a base station.

In one embodiment, the NR node B is a cell.

In one embodiment, the NR node B comprises multiple cells.

In one embodiment, the NR node B is used to determine transmissions on multiple serving cells.

In one embodiment, the first node in the present application corresponds to the UE201, and the second node in the present application corresponds to the NR node B.

In one embodiment, the first node and the second node in the present application are respectively the UE201 and the gNB203.

In one embodiment, the first node in the present application is the UE 201, and the second node in the present application is the UE241.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first node is a terminal.

In one embodiment, the first node is a relay.

In one embodiment, the second node is a terminal.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used for managing multiple TRPs.

In one embodiment, the second node is used for managing multiple nodes of cells.

In one embodiment, the second node is used for managing multiple nodes of serving cells.

In one embodiment, the first DCI is generated by the PHY 301 or the PHY 351.

In one embodiment, the first radio signal is generated by the PHY 301 or the PHY 351.

In one embodiment, the higher layer in the present application refers to a layer above the PHY layer.

### Embodiment 4

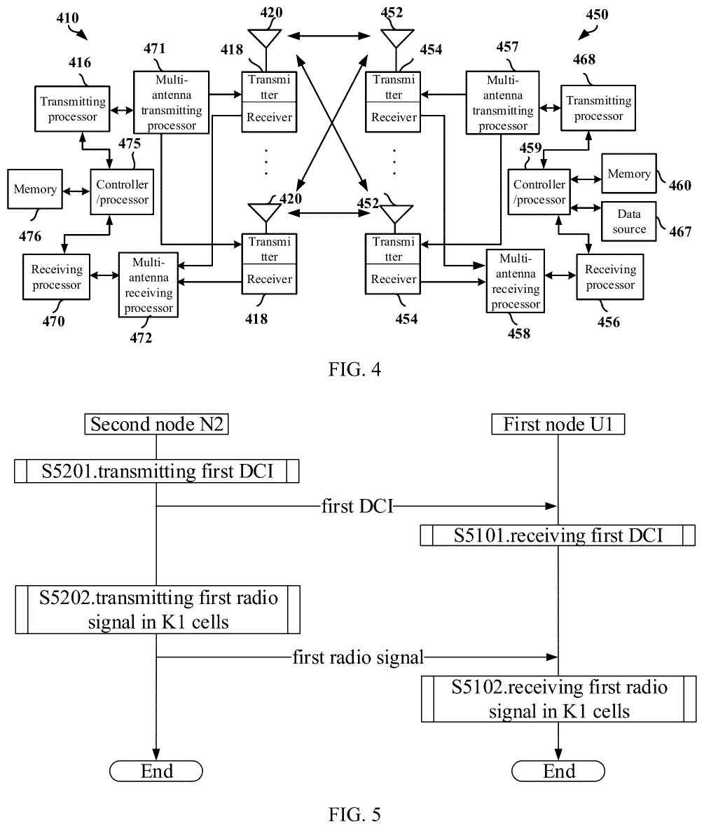

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with the memory 460 that stores program code and data: the memory 460 may be called a computer readable medium. In DownLink (DL) transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data: the memory 476 may be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes: the at least one memory and the computer program codes are configured to be used in collaboration with the at least one processor. The second communication device 450 at least receives a first DCI, the first DCI scheduling a first cell set, the first cell set comprising K1 cells; and receives or transmits a first radio signal in the K1 cells; herein the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the second communication device 450 comprises a memory that stores a computer readable instruction program. The computer readable instruction program generates actions when executed by at least one processor. The actions include: receiving a first DCI, the first DCI scheduling a first cell set, the first cell set comprising K1 cells; and receiving or transmitting a first radio signal in the K1 cells: herein the first DCI indicates a first symbol set, the first radio signal occupying the first symbol set in time domain; a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the first communication device 410 comprises at least one processor and at least one memory: The at least one memory comprises computer program codes: the at least one memory and the computer program codes are configured to be used in collaboration with the at least one processor. The first communication device 410 at least transmits a first DCI, the first DCI scheduling a first cell set, the first cell set comprising K1 cells; and transmits or receives a first radio signal in the K1 cells: herein the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the first communication device 410 comprises a memory that stores a computer readable instruction program. The computer readable instruction program generates actions when executed by at least one processor. The actions include: transmitting a first DCI, the first DCI scheduling a first cell set, the first cell set comprising K1 cells; and transmitting or receiving a first radio signal in the K1 cells; herein the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive the first DCI in the present application: at least one of the antenna 420, the transmitter 418, the transmitting processor 416, the multi-antenna transmitting processor 471, the controller/processor 475 or the memory 476 is used to transmit the first DCI in the present application.

In one embodiment, at least one of the antenna 452, the receiver 454, the receiving processor 456, the multi-antenna receiving processor 458, the controller/processor 459, the memory 460 or the data source 467 is used to receive the first radio signal in the present application: at least one of the antenna 420, the transmitter 418, the transmitting processor 416, the multi-antenna transmitting processor 471, the controller/processor 475 or the memory 476 is used to transmit the first radio signal in the present application.

In one embodiment, at least one of the antenna 452, the transmitter 454, the transmitting processor 468, the multi-antenna transmitting processor 457, the controller/processor 459 or the memory 460 is used to transmit the first radio signal in the present application: at least one of the antenna 420, the receiver 418, the receiving processor 470, the multi-antenna receiving processor 472, the controller/processor 475 or the memory 476 is used to receive the first radio signal in the present application.

### Embodiment 5

Embodiment 5 illustrates a flowchart of wireless transmission according to one embodiment of the present application, as shown in FIG. 5. In FIG. 5, a first node U1 and a second node N2 are respectively two communication nodes that transmit via an air interface.

The first node U1 receives the first DCI in step S5101; and receives the first radio signal in the K1 cells in step S5102.

The second node N2 transmits the first DCI in step S5201; and transmits the first radio signal in the K1 cells in step S5202.

In Embodiment 5, the first DCI schedules a first cell set, the first cell set comprising K1 cells; the first DCI indicates a first symbol set, the first radio signal occupying the first symbol set in time domain; a first field set in the first DCI is applied to a target cell in the first cell set; an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the first node U1 is the first node in the present application.

In one embodiment, the second node N2 is the second node in the present application.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, a physical channel occupied by the first DCI includes a Physical Downlink Control Channel (PDCCH).

In one embodiment, a physical channel occupied by the first radio signal includes a Physical Downlink Shared Channel (PDSCH).

In one embodiment, a physical layer channel occupied by the first radio signal includes a Physical Downlink Control Channel (PDCCH).

### Embodiment 6

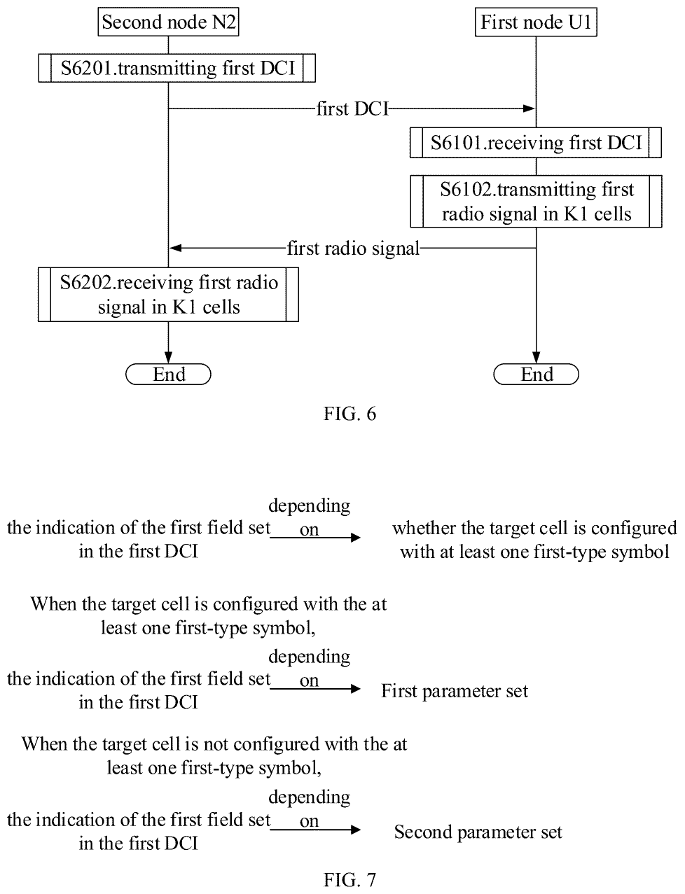

Embodiment 6 illustrates a flowchart of wireless transmission according to another embodiment of the present application, as shown in FIG. 6. In FIG. 6, a first node U1 and a second node N2 are respectively two communication nodes that transmit via an air interface.

The first node U1 receives the first DCI in step S6101; and transmits the first radio signal in the K1 cells in step S6102.

The second node N2 transmits the first DCI in step S6201; and receives the first radio signal in the K1 cells in step S6202.

In Embodiment 6, the first DCI schedules a first cell set, the first cell set comprising K1 cells; the first DCI indicates a first symbol set, the first radio signal occupying the first symbol set in time domain; a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

In one embodiment, the first node U1 is the first node in the present application.

In one embodiment, the second node N2 is the second node in the present application.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, a physical channel occupied by the first DCI includes a Physical Downlink Control Channel (PDCCH).

In one embodiment, a physical channel occupied by the first radio signal includes a Physical Uplink Shared Channel (PUSCH).

In one embodiment, a physical layer channel occupied by the first radio signal includes a Physical Uplink Control Channel (PUCCH).

### Embodiment 7

Embodiment 7 illustrates a schematic diagram of an indication of a first field set according to one embodiment of the present application, as shown in FIG. 7.

In Embodiment 7, the indication of the first field set in the first DCI depends on whether the target cell is configured with at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

In one embodiment, the first field set in the first DCI comprises only one field.

In one embodiment, the first field set in the first DCI comprises multiple fields.

In one embodiment, the first parameter set comprises only one parameter.

In one embodiment, the first parameter set comprises only multiple parameters.

In one embodiment, the first parameter set comprises one or more fields in a PDSCH-Config IE.

In one embodiment, the first parameter set comprises one or more fields in a PDSCH-ConfigCommon IE.

In one embodiment, the first parameter set comprises one or more fields in a PUSCH-Config IE.

In one embodiment, the first parameter set comprises one or more fields in a PUSCH-ConfigCommon IE.

In one embodiment, the first parameter set comprises one or more fields in an SRS-Config IE.

In one embodiment, the first parameter set comprises one or more fields in a PUCCH-config IE.

In one embodiment, the first parameter set comprises one or more fields in a PhysicalCellGroupConfig IE.

In one embodiment, the first parameter set comprises one or more fields in a BWP-Uplink IE.

In one embodiment, the first parameter set comprises one or more fields in a BWP-Downlink IE.

In one embodiment, one parameter in the first parameter set is a parameter configured by an RRC signaling.

In one embodiment, one parameter in the first parameter set is a parameter configured by a higher layer signaling.

In one embodiment, one parameter in the first parameter set is a configuration state.

In one embodiment, one parameter in the first parameter set denotes a configuration state.

In one embodiment, one parameter in the first parameter set includes a configuration state.

In one embodiment, one parameter in the first parameter set is used to indicate a configuration state.

In one embodiment, one parameter in the first parameter set is a configurable value.

In one embodiment, one parameter in the first parameter set is used to indicate a configurable value.

In one embodiment, the first field set in the first DCI comprises a Time Domain Resource Assignment field, and at least one parameter included in the first parameter set corresponds to pdsch-TimeDomainAllocationListDCI-x-y in a PDSCH-Config IE, where x-y corresponds to a DCI format of the first DCI.

In one embodiment, the first field set in the first DCI comprises a Time Domain Resource Assignment field, and at least one parameter included in the first parameter set corresponds to pdsch-TimeDomainAllocationListDCI-x-y in a PDSCH-ConfigCommon IE, where x-y corresponds to a DCI format of the first DCI.

In one embodiment, the first field set in the first DCI comprises a Time Domain Resource Assignment field, and at least one parameter included in the first parameter set corresponds to pusch-TimeDomainAllocationListDCI-x-y in a PUSCH-Config IE, where x-y corresponds to a DCI format of the first DCI.

In one embodiment, the first field set in the first DCI comprises a Time Domain Resource Assignment field, and at least one parameter included in the first parameter set corresponds to pusch-TimeDomainAllocationListDCI-x-y in a PUSCH-ConfigCommon IE, where x-y corresponds to a DCI format of the first DCI.

In one embodiment, the first field set in the first DCI comprises a VRB-to-PRB mapping field, and at least one parameter included in the first parameter set corresponds to vrb-ToPRB-InterleaverDCI-x-y in a PDSCH-Config IE, where x-y corresponds to a DCI format of the first DCI.

In one embodiment, the first field set in the first DCI comprises an Antenna port(s) field, and at least one parameter included in the first parameter set corresponds to antennaPortsFieldPresenceDCI-x-y in a PDSCH-config IE, where x-y corresponds to a DCI format of the first DCI.

In one embodiment, the first field set in the first DCI comprises an Antenna port(s) field, and at least one parameter included in the first parameter set corresponds to antennaPortsFieldPresenceDCI-x-y in a PUSCH-config IE, where x-y corresponds to a DCI format of the first DCI.

In one embodiment, the first field set in the first DCI comprises an Antenna port(s) field, and at least one parameter included in the first parameter set corresponds to antenna port(s) used by a signal scheduled by the first DCI.

In one embodiment, the first field set in the first DCI comprises a DMRS sequence initialization field, and at least one parameter included in the first parameter set corresponds to dmrs-SequenceInitializationDCI-x-y in a PDSCH-config IE, where x-y corresponds to a DCI format of the first DCI.

In one embodiment, the first field set in the first DCI comprises a DMRS sequence initialization field, and at least one parameter included in the first parameter set corresponds to dmrs-SequenceInitializationDCI-x-y in a PUSCH-config IE, where x-y corresponds to a DCI format of the first DCI.

In one embodiment, the first field set in the first DCI comprises a priority indicator field, and at least one parameter included in the first parameter set corresponds to priority IndicatorDCI-x-y in a PDSCH-config IE, where x-y corresponds to a DCI format of the first DCI.

In one embodiment, the first field set in the first DCI comprises a priority indicator field, and at least one parameter included in the first parameter set corresponds to priority IndicatorDCI-x-y in a PUSCH-config IE, where x-y corresponds to a DCI format of the first DCI.

In one embodiment, the first field set in the first DCI comprises a PRB bundling size indicator field, and at least one parameter included in the first parameter set corresponds to prb-Bundling TypeDCI-x-y in a PDSCH-config IE, where x-y corresponds to a DCI format of the first DCI.

In one embodiment, the first field set in the first DCI comprises an Enhanced Type 3 codebook indicator field, and at least one parameter included in the first parameter set corresponds to pdsch-HARQ-ACK-EnhType3DCI-x-y in a PDSCH-config IE, where x-y corresponds to a DCI format of the first DCI.

In one embodiment, the first field set in the first DCI comprises an Enhanced Type 3 codebook indicator field, and at least one parameter included in the first parameter set corresponds to pdsch-HARQ-ACK-EnhType3-rX in a PhysicalCellGroupConfig IE, where-rX indicates release version X.

In one embodiment, the first field set in the first DCI comprises a HARQ-ACK retransmission indicator field, and at least one parameter included in the first parameter set corresponds to pdsch-HARQ-ACK-RetxDCI-x-y in a PDSCH-config IE, where x-y corresponds to a DCI format of the first DCI.

In one embodiment, the first field set in the first DCI comprises a HARQ-ACK retransmission indicator field, and at least one parameter included in the first parameter set corresponds to pdsch-HARQ-ACK-Retx-rX in a PhysicalCellGroupConfig IE, where-rX indicates release version X.

In one embodiment, the first field set in the first DCI comprises a PUCCH Cell indicator field, and at least one parameter included in the first parameter set corresponds to pucch-sSCellDynDCI-x-y in a PDSCH-config IE, where x-y corresponds to a DCI format of the first DCI.

In one embodiment, the first field set in the first DCI comprises a PUCCH Cell indicator field, and at least one parameter included in the first parameter set corresponds to pucch-sSCellDyn-rX in a PhysicalCellGroupConfig IE, where-rX indicates release version X.

In one embodiment, the first field set in the first DCI comprises a Frequency hopping flag field, and at least one parameter included in the first parameter set corresponds to frequency HoppingDCI-x-y in a PUSCH-config IE, where x-y corresponds to a DCI format of the first DCI.

In one embodiment, the first field set in the first DCI comprises a Frequency hopping flag field, and at least one parameter included in the first parameter set corresponds to frequency HoppingOffsetListsDCI-x-y in a PUSCH-config IE, where x-y corresponds to a DCI format of the first DCI.

In one embodiment, the first field set in the first DCI comprises an SRS resource indicator field, and at least one parameter included in the first parameter set corresponds to srs-Resource ToAddModList in an SRS-Config IE.

In one embodiment, the first field set in the first DCI comprises a beta_offset indicator field, and at least one parameter included in the first parameter set corresponds to betaOffsetsCrossPri0DCI-x-y in a PUSCH-config IE, where x-y corresponds to a DCI format of the first DCI.

In one embodiment, the first field set in the first DCI comprises a beta_offset indicator field, and at least one parameter included in the first parameter set corresponds to betaOffsetsCrossPri1DCI-x-y in a PUSCH-config IE, where x-y corresponds to a DCI format of the first DCI.

In one embodiment, the first field set in the first DCI comprises a Bandwidth part indicator field, and at least one parameter included in the first parameter set corresponds to BWP-Id in a BWP-Uplink IE.

In one embodiment, the first field set in the first DCI comprises a Bandwidth part indicator field, and at least one parameter included in the first parameter set corresponds to BWP-Id in a BWP-Downlink IE.

In one embodiment, the first field set in the first DCI comprises a ChannelAccess-CPext field, and at least one parameter included in the first parameter set corresponds to ul-AccessConfigListDCI-x-y in a PUCCH-config IE, where x-y corresponds to a DCI format of the first DCI.

In one embodiment, the first field set in the first DCI comprises a ChannelAccess-CPext-CAPC field, and at least one parameter included in the first parameter set corresponds to ul-AccessConfigListDCI-x-y in a PUCCH-config IE, where x-y corresponds to a DCI format of the first DCI.

In one embodiment, the first field set in the first DCI comprises a field of Precoding information and number of layers, and at least one parameter included in the first parameter set corresponds to precoding AndNumberOfLayers in a ConfiguredGrantConfig IE.

In one embodiment, the first field set in the first DCI comprises a field of Open-loop power control parameter set indication, and at least one parameter included in the first parameter set corresponds to olpc-ParameterSetDCI-x-y in a PUSCH-PowerControl IE, where x-y corresponds to a DCI format of the first DCI.

In one embodiment, the first field set in the first DCI comprises an SRS request field, and at least one parameter included in the first parameter set corresponds to srs-RequestDCI-x-y in an SRS-Config IE, where x-y corresponds to a DCI format of the first DCI.

In one embodiment, the first field set in the first DCI comprises an SRS offset indicator field, and at least one parameter included in the first parameter set corresponds to AvailableSlotOffset-rX in an SRS-Config IE, where-rX indicates release version X.

In one embodiment, the first field set in the first DCI comprises a ZP CSI-RS trigger field, and at least one parameter included in the first parameter set corresponds to rateMatchPattern ToAddModList-rX in a PDSCH-Config IE, where-rX indicates release version X.

In one embodiment, the first field set in the first DCI comprises a Transmission configuration indication field, and at least one parameter included in the first parameter set corresponds to tci-PresentInDCI in a ControlResourceSet IE.

In one embodiment, the first field set in the first DCI comprises a Transmission configuration indication field, and at least one parameter included in the first parameter set corresponds to TCI-StateId in a TCI-State IE.

In one embodiment, the first field set in the first DCI comprises a Transmission configuration indication field, and at least one parameter included in the first parameter set corresponds to TCI-UL-StateId in a TCI-UL-State IE.

In one embodiment, the first field set in the first DCI comprises a field of TPC command for scheduled PUCCH, and at least one parameter included in the first parameter set corresponds to pucch-PowerControl in a PUCCH-Config IE.

In one embodiment, the first field set in the first DCI comprises a PDSCH-to-HARQ_feedback timing indicator field, and at least one parameter included in the first parameter set corresponds to dl-DataToUL-ACK-DCI-x-y in a PUCCH-Config IE, where x-y corresponds to a DCI format of the first DCI.

In one embodiment, the first field set in the first DCI comprises a Downlink assignment index field, and at least one parameter included in the first parameter set corresponds to pdsch-HARQ-ACK-Codebook-rX in a PhysicalCellGroupConfig IE, where-rX indicates release version X.

In one embodiment, the first field set in the first DCI comprises a PUCCH resource indicator field, and at least one parameter included in the first parameter set corresponds to resourceList in a PUCCH-Config IE.

In one embodiment, the first field set in the first DCI comprises a One-shot HARQ-ACK request field, and at least one parameter included in the first parameter set corresponds to pdsch-HARQ-ACK-OneShotFeedback DCI-x-y in a PDSCH-Config IE, where x-y corresponds to a DCI format of the first DCI.

In one embodiment, the first field set in the first DCI comprises a One-shot HARQ-ACK request field, and at least one parameter included in the first parameter set corresponds to pdsch-HARQ-ACK-OneShotFeedback-rX in a PhysicalCellGroupConfig IE, where-rX indicates release version X.

In one embodiment, the name of at least one parameter included in the first parameter set includes TimeDomainAllocation.

In one embodiment, the name of at least one parameter included in the first parameter set includes pdsch-TimeDomainAllocationList.

In one embodiment, the name of at least one parameter included in the first parameter set includes pusch-TimeDomainAllocationList.

In one embodiment, the name of at least one parameter included in the first parameter set includes vrb-ToPRB-Interleaver.

In one embodiment, the name of at least one parameter included in the first parameter set includes antennaPort.

In one embodiment, the name of at least one parameter included in the first parameter set includes dmrs-SequenceInitialization.

In one embodiment, the name of at least one parameter included in the first parameter set includes priority Indicator.

In one embodiment, the name of at least one parameter included in the first parameter set includes prb-Bundling Type.

In one embodiment, the name of at least one parameter included in the first parameter set includes pdsch-HARQ-ACK-EnhType3.

In one embodiment, the name of at least one parameter included in the first parameter set includes pdsch-HARQ-ACK-Retx.

In one embodiment, the name of at least one parameter included in the first parameter set includes pucch-sSCellDyn.

In one embodiment, the name of at least one parameter included in the first parameter set includes frequency Hopping.

In one embodiment, the name of at least one parameter included in the first parameter set includes frequency Hopping Offset.

In one embodiment, the name of at least one parameter included in the first parameter set includes srs-Resource.

In one embodiment, the name of at least one parameter included in the first parameter set includes betaOffsetsCrossPri0.

In one embodiment, the name of at least one parameter included in the first parameter set includes betaOffsetsCrossPri1.

In one embodiment, the name of at least one parameter included in the first parameter set includes bwp.

In one embodiment, the name of at least one parameter included in the first parameter set includes ul-AccessConfigList.

In one embodiment, the name of at least one parameter included in the first parameter set includes precoding AndNumberOfLayers.

In one embodiment, the name of at least one parameter included in the first parameter set includes olpc-ParameterSet.

In one embodiment, the name of at least one parameter included in the first parameter set includes srs-Request.

In one embodiment, the name of at least one parameter included in the first parameter set includes AvailableSlotOffset.

In one embodiment, the name of at least one parameter included in the first parameter set includes RateMatchPattern.

In one embodiment, the name of at least one parameter included in the first parameter set includes tci-PresentInDCI.

In one embodiment, the name of at least one parameter included in the first parameter set includes zp-CSI-RS-Resource.

In one embodiment, the name of at least one parameter included in the first parameter set includes TCI-State.

In one embodiment, the name of at least one parameter included in the first parameter set includes TCI-UL-State.

In one embodiment, the name of at least one parameter included in the first parameter set includes pucch-PowerControl.

In one embodiment, the name of at least one parameter included in the first parameter set includes dl-DataToUL-ACK.

In one embodiment, the name of at least one parameter included in the first parameter set includes pdsch-HARQ-ACK-Codebook.

In one embodiment, the name of at least one parameter included in the first parameter set includes resource List.

In one embodiment, the name of at least one parameter included in the first parameter set includes pdsch-HARQ-ACK-OneShotFeedback.

In one embodiment, the name of at least one parameter included in the first parameter set includes-r18.

In one embodiment, the name of at least one parameter included in the first parameter set includes-r19.

In one embodiment, the name of at least one parameter included in the first parameter set includes-r20.

In one embodiment, the second parameter set comprises only one parameter.

In one embodiment, the second parameter set comprises only multiple parameters.

In one embodiment, the second parameter set comprises one or more fields in a PDSCH-Config IE.

In one embodiment, the second parameter set comprises one or more fields in a PDSCH-ConfigCommon IE.

In one embodiment, the second parameter set comprises one or more fields in a PUSCH-Config IE.

In one embodiment, the second parameter set comprises one or more fields in a PUSCH-ConfigCommon IE.

In one embodiment, the second parameter set comprises one or more fields in an SRS-Config IE.

In one embodiment, the second parameter set comprises one or more fields in a PUCCH-config IE.

In one embodiment, the second parameter set comprises one or more fields in a PhysicalCellGroupConfig IE.

In one embodiment, the second parameter set comprises one or more fields in a BWP-Uplink IE.

In one embodiment, the second parameter set comprises one or more fields in a BWP-Downlink IE.

In one embodiment, one parameter in the second parameter set is a parameter configured by an RRC signaling.

In one embodiment, one parameter in the second parameter set is a parameter configured by a higher layer signaling.

In one embodiment, one parameter in the second parameter set is a configuration state.

In one embodiment, one parameter in the second parameter set denotes a configuration state.

In one embodiment, one parameter in the second parameter set includes a configuration state.

In one embodiment, one parameter in the second parameter set is used to indicate a configuration state.

In one embodiment, one parameter in the second parameter set is a configurable value.

In one embodiment, one parameter in the second parameter set is used to indicate a configurable value.

In one embodiment, the first field set in the first DCI comprises a Time Domain Resource Assignment field, and at least one parameter included in the second parameter set corresponds to pdsch-TimeDomainAllocationListDCI-x-y in a PDSCH-Config IE, where x-y corresponds to a DCI format of the first DCI.

In one embodiment, the first field set in the first DCI comprises a Time Domain Resource Assignment field, and at least one parameter included in the second parameter set corresponds to pdsch-TimeDomainAllocationListDCI-x-y in a PDSCH-ConfigCommon IE, where x-y corresponds to a DCI format of the first DCI.

In one embodiment, the first field set in the first DCI comprises a Time Domain Resource Assignment field, and at least one parameter included in the second parameter set corresponds to pusch-TimeDomainAllocationListDCI-x-y in a PUSCH-Config IE, where x-y corresponds to a DCI format of the first DCI.

In one embodiment, the first field set in the first DCI comprises a Time Domain Resource Assignment field, and at least one parameter included in the second parameter set corresponds to pusch-TimeDomainAllocationListDCI-x-y in a PUSCH-ConfigCommon IE, where x-y corresponds to a DCI format of the first DCI.

In one embodiment, the first field set in the first DCI comprises a VRB-to-PRB mapping field, and at least one parameter included in the second parameter set corresponds to vrb-ToPRB-InterleaverDCI-x-y in a PDSCH-Config IE, where x-y corresponds to a DCI format of the first DCI.

In one embodiment, the first field set in the first DCI comprises an Antenna port(s) field, and at least one parameter included in the second parameter set corresponds to antennaPortsFieldPresenceDCI-x-y in a PDSCH-config IE, where x-y corresponds to a DCI format of the first DCI.

In one embodiment, the first field set in the first DCI comprises an Antenna port(s) field, and at least one parameter included in the second parameter set corresponds to antennaPortsFieldPresenceDCI-x-y in a PUSCH-config IE, where x-y corresponds to a DCI format of the first DCI.

In one embodiment, the first field set in the first DCI comprises an Antenna port(s) field, and at least one parameter included in the second parameter set corresponds to antenna port(s) used by a signal scheduled by the first DCI.

In one embodiment, the first field set in the first DCI comprises a DMRS sequence initialization field, and at least one parameter included in the second parameter set corresponds to dmrs-SequenceInitializationDCI-x-y in a PDSCH-config IE, where x-y corresponds to a DCI format of the first DCI.

In one embodiment, the first field set in the first DCI comprises a DMRS sequence initialization field, and at least one parameter included in the second parameter set corresponds to dmrs-SequenceInitializationDCI-x-y in a PUSCH-config IE, where x-y corresponds to a DCI format of the first DCI.

In one embodiment, the first field set in the first DCI comprises a priority indicator field, and at least one parameter included in the second parameter set corresponds to priority IndicatorDCI-x-y in a PDSCH-config IE, where x-y corresponds to a DCI format of the first DCI.

In one embodiment, the first field set in the first DCI comprises a priority indicator field, and at least one parameter included in the second parameter set corresponds to priority IndicatorDCI-x-y in a PUSCH-config IE, where x-y corresponds to a DCI format of the first DCI.

In one embodiment, the first field set in the first DCI comprises a PRB bundling size indicator field, and at least one parameter included in the second parameter set corresponds to prb-Bundling TypeDCI-x-y in a PDSCH-config IE, where x-y corresponds to a DCI format of the first DCI.

In one embodiment, the first field set in the first DCI comprises an Enhanced Type 3 codebook indicator field, and at least one parameter included in the second parameter set corresponds to pdsch-HARQ-ACK-EnhType3DCI-x-y in a PDSCH-config IE, where x-y corresponds to a DCI format of the first DCI.

In one embodiment, the first field set in the first DCI comprises an Enhanced Type 3 codebook indicator field, and at least one parameter included in the second parameter set corresponds to pdsch-HARQ-ACK-EnhType3-rX in a PhysicalCellGroupConfig IE, where-rX indicates release version X.

In one embodiment, the first field set in the first DCI comprises a HARQ-ACK retransmission indicator field, and at least one parameter included in the second parameter set corresponds to pdsch-HARQ-ACK-RetxDCI-x-y in a PDSCH-config IE, where x-y corresponds to a DCI format of the first DCI.

In one embodiment, the first field set in the first DCI comprises a HARQ-ACK retransmission indicator field, and at least one parameter included in the second parameter set corresponds to pdsch-HARQ-ACK-Retx-rX in a PhysicalCellGroupConfig IE, where-rX indicates release version X.

In one embodiment, the first field set in the first DCI comprises a PUCCH Cell indicator field, and at least one parameter included in the second parameter set corresponds to pucch-sSCellDynDCI-x-y in a PDSCH-config IE, where x-y corresponds to a DCI format of the first DCI.

In one embodiment, the first field set in the first DCI comprises a PUCCH Cell indicator field, and at least one parameter included in the second parameter set corresponds to pucch-sSCellDyn-rX in a PhysicalCellGroupConfig IE, where-rX indicates release version X.

In one embodiment, the first field set in the first DCI comprises a Frequency hopping flag field, and at least one parameter included in the second parameter set corresponds to frequency HoppingDCI-x-y in a PUSCH-config IE, where x-y corresponds to a DCI format of the first DCI.

In one embodiment, the first field set in the first DCI comprises a Frequency hopping flag field, and at least one parameter included in the second parameter set corresponds to frequency Hopping OffsetListsDCI-x-y in a PUSCH-config IE, where x-y corresponds to a DCI format of the first DCI.

In one embodiment, the first field set in the first DCI comprises an SRS resource indicator field, and at least one parameter included in the second parameter set corresponds to srs-ResourceToAddModList in an SRS-Config IE.

In one embodiment, the first field set in the first DCI comprises a beta_offset indicator field, and at least one parameter included in the second parameter set corresponds to betaOffsetsCrossPri0DCI-x-y in a PUSCH-config IE, where x-y corresponds to a DCI format of the first DCI.

In one embodiment, the first field set in the first DCI comprises a beta_offset indicator field, and at least one parameter included in the second parameter set corresponds to betaOffsetsCrossPri1DCI-x-y in a PUSCH-config IE, where x-y corresponds to a DCI format of the first DCI.

In one embodiment, the first field set in the first DCI comprises a Bandwidth part indicator field, and at least one parameter included in the second parameter set corresponds to BWP-Id in a BWP-Uplink IE.

In one embodiment, the first field set in the first DCI comprises a Bandwidth part indicator field, and at least one parameter included in the second parameter set corresponds to BWP-Id in a BWP-Downlink IE.

In one embodiment, the first field set in the first DCI comprises a ChannelAccess-CPext field, and at least one parameter included in the second parameter set corresponds to ul-AccessConfigListDCI-x-y in a PUCCH-config IE, where x-y corresponds to a DCI format of the first DCI.

In one embodiment, the first field set in the first DCI comprises a ChannelAccess-CPext-CAPC field, and at least one parameter included in the second parameter set corresponds to ul-AccessConfigListDCI-x-y in a PUCCH-config IE, where x-y corresponds to a DCI format of the first DCI.

In one embodiment, the first field set in the first DCI comprises a field of Precoding information and number of layers, and at least one parameter included in the second parameter set corresponds to precoding AndNumberOfLayers in a ConfiguredGrantConfig IE.

In one embodiment, the first field set in the first DCI comprises a field of Open-loop power control parameter set indication, and at least one parameter included in the second parameter set corresponds to olpc-ParameterSetDCI-x-y in a PUSCH-PowerControl IE, where x-y corresponds to a DCI format of the first DCI.

In one embodiment, the first field set in the first DCI comprises an SRS request field, and at least one parameter included in the second parameter set corresponds to srs-RequestDCI-x-y in an SRS-Config IE, where x-y corresponds to a DCI format of the first DCI.

In one embodiment, the first field set in the first DCI comprises an SRS offset indicator field, and at least one parameter included in the second parameter set corresponds to AvailableSlotOffset-rX in an SRS-Config IE, where-rX indicates release version X.

In one embodiment, the first field set in the first DCI comprises a ZP CSI-RS trigger field, and at least one parameter included in the second parameter set corresponds to rateMatchPatternToAddModList-rX in a PDSCH-Config IE, where-rX indicates release version X.

In one embodiment, the first field set in the first DCI comprises a Transmission configuration indication field, and at least one parameter included in the second parameter set corresponds to tci-PresentInDCI in a ControlResourceSet IE.

In one embodiment, the first field set in the first DCI comprises a Transmission configuration indication field, and at least one parameter included in the second parameter set corresponds to TCI-StateId in a TCI-State IE.

In one embodiment, the first field set in the first DCI comprises a Transmission configuration indication field, and at least one parameter included in the second parameter set corresponds to TCI-UL-StateId in a TCI-UL-State IE.

In one embodiment, the first field set in the first DCI comprises a field of TPC command for scheduled PUCCH, and at least one parameter included in the second parameter set corresponds to pucch-PowerControl in a PUCCH-Config IE.

In one embodiment, the first field set in the first DCI comprises a PDSCH-to-HARQ_feedback timing indicator field, and at least one parameter included in the second parameter set corresponds to dl-DataToUL-ACK-DCI-x-y in a PUCCH-Config IE, where x-y corresponds to a DCI format of the first DCI.

In one embodiment, the first field set in the first DCI comprises a Downlink assignment index field, and at least one parameter included in the second parameter set corresponds to pdsch-HARQ-ACK-Codebook-rX in a PhysicalCellGroupConfig IE, where-rX indicates release version X.

In one embodiment, the first field set in the first DCI comprises a PUCCH resource indicator field, and at least one parameter included in the second parameter set corresponds to resourceList in a PUCCH-Config IE.

In one embodiment, the first field set in the first DCI comprises a One-shot HARQ-ACK request field, and at least one parameter included in the second parameter set corresponds to pdsch-HARQ-ACK-OneShotFeedback DCI-x-y in a PDSCH-Config IE, where x-y corresponds to a DCI format of the first DCI.

In one embodiment, the first field set in the first DCI comprises a One-shot HARQ-ACK request field, and at least one parameter included in the second parameter set corresponds to pdsch-HARQ-ACK-OneShotFeedback-rX in a PhysicalCellGroupConfig IE, where-rX indicates release version X.

In one embodiment, the name of at least one parameter included in the second parameter set includes TimeDomainAllocation.

In one embodiment, the name of at least one parameter included in the second parameter set includes pdsch-TimeDomainAllocationList.

In one embodiment, the name of at least one parameter included in the second parameter set includes pusch-TimeDomainAllocationList.

In one embodiment, the name of at least one parameter included in the second parameter set includes vrb-ToPRB-Interleaver.

In one embodiment, the name of at least one parameter included in the second parameter set includes antennaPort.

In one embodiment, the name of at least one parameter included in the second parameter set includes dmrs-SequenceInitialization.

In one embodiment, the name of at least one parameter included in the second parameter set includes priority Indicator.

In one embodiment, the name of at least one parameter included in the second parameter set includes prb-Bundling Type.

In one embodiment, the name of at least one parameter included in the second parameter set includes pdsch-HARQ-ACK-EnhType3.

In one embodiment, the name of at least one parameter included in the second parameter set includes pdsch-HARQ-ACK-Retx.

In one embodiment, the name of at least one parameter included in the second parameter set includes pucch-sSCellDyn.

In one embodiment, the name of at least one parameter included in the second parameter set includes frequency Hopping.

In one embodiment, the name of at least one parameter included in the second parameter set includes frequency Hopping Offset.

In one embodiment, the name of at least one parameter included in the second parameter set includes srs-Resource.

In one embodiment, the name of at least one parameter included in the second parameter set includes betaOffsetsCrossPri0.

In one embodiment, the name of at least one parameter included in the second parameter set includes betaOffsetsCrossPri1.

In one embodiment, the name of at least one parameter included in the second parameter set includes bwp.

In one embodiment, the name of at least one parameter included in the second parameter set includes ul-AccessConfigList.

In one embodiment, the name of at least one parameter included in the second parameter set includes precoding AndNumberOfLayers.

In one embodiment, the name of at least one parameter included in the second parameter set includes olpc-ParameterSet.

In one embodiment, the name of at least one parameter included in the second parameter set includes srs-Request.

In one embodiment, the name of at least one parameter included in the second parameter set includes AvailableSlotOffset.

In one embodiment, the name of at least one parameter included in the second parameter set includes RateMatchPattern.

In one embodiment, the name of at least one parameter included in the second parameter set includes tci-PresentInDCI.

In one embodiment, the name of at least one parameter included in the second parameter set includes zp-CSI-RS-Resource.

In one embodiment, the name of at least one parameter included in the second parameter set includes TCI-State.

In one embodiment, the name of at least one parameter included in the second parameter set includes TCI-UL-State.

In one embodiment, the name of at least one parameter included in the second parameter set includes pucch-PowerControl.

In one embodiment, the name of at least one parameter included in the second parameter set includes dl-DataToUL-ACK.

In one embodiment, the name of at least one parameter included in the second parameter set includes pdsch-HARQ-ACK-Codebook.

In one embodiment, the name of at least one parameter included in the second parameter set includes resourceList.

In one embodiment, the name of at least one parameter included in the second parameter set includes pdsch-HARQ-ACK-OneShotFeedback.

In one embodiment, the name of at least one parameter included in the second parameter set includes −r18.

In one embodiment, the name of at least one parameter included in the second parameter set includes −r19.

In one embodiment, the name of at least one parameter included in the second parameter set includes −r20.

In one embodiment, that the indication of the first field set in the first DCI depends on a first parameter set means that the first field set in the first DCI refers to configuration of the first parameter set.

In one embodiment, that the indication of the first field set in the first DCI depends on a first parameter set means that at least one field in the first field set in the first DCI is used to indicate one parameter out of multiple parameters configured in the first parameter set.

In one embodiment, that the indication of the first field set in the first DCI depends on a first parameter set means that the interpretation of at least one field in the first field set in the first DCI refers to the first parameter set.

In one embodiment, that the indication of the first field set in the first DCI depends on a first parameter set means that the indication of each field in the first field set in the first DCI depends on at least one parameter in the first parameter set.

In one embodiment, that the indication of the first field set in the first DCI depends on a first parameter set means that the indication content of at least one field in the first field set in the first DCI depends on at least one parameter in the first parameter set.

In one embodiment, that the indication of the first field set in the first DCI depends on a first parameter set means that the indication method of at least one field in the first field set in the first DCI depends on at least one parameter in the first parameter set.

In one embodiment, that the indication of the first field set in the first DCI depends on a first parameter set means that the size of at least one field in the first field set in the first DCI depends on at least one parameter in the first parameter set.

In one embodiment, that the indication of the first field set in the first DCI depends on a first parameter set means that the presence of at least one field in the first field set in the first DCI depends on at least one parameter in the first parameter set.

In one embodiment, that the indication of the first field set in the first DCI depends on a first parameter set means that the indication of at least one field in the first field set in the first DCI is based on a table that depends on at least one parameter in the first parameter set.

In one embodiment, that the indication of the first field set in the first DCI depends on a first parameter set means that a field in the first field set in the first DCI indicates a value in a range of values, at least one parameter in the first parameter set being used to configure this range of values.

In one embodiment, that the indication of the first field set in the first DCI depends on a first parameter set means that what is indicated by a field in the first field set in the first DCI is indicated by a parameter in the first parameter set.

In one embodiment, that the indication of the first field set in the first DCI depends on a first parameter set means that the meaning of bit in at least one field in the first field set in the first DCI depends on at least one parameter in the first parameter set.

In one embodiment, that the indication of the first field set in the first DCI depends on a first parameter set means that what is indicated by the value of at least one field in the first field set in the first DCI depends on at least one parameter in the first parameter set.

In one embodiment, the expression depending on the first parameter set comprises: indicated by at least one parameter in the first parameter set or indicated jointly by multiple parameters including at least one parameter in the first parameter set.

In one embodiment, the expression depending on the first parameter set comprises: determined based on at least one parameter in the first parameter set.

In one embodiment, the expression depending on the first parameter set comprises: determined based on configuration information indicated by at least one parameter in the first parameter set.

In one embodiment, the expression depending on the first parameter set comprises: determined based on the configuration information included in at least one parameter in the first parameter set.

In one embodiment, the expression depending on the first parameter set comprises: determined based on the configuration information indicated by at least one parameter in the first parameter set.

In one embodiment, that the indication of the first field set in the first DCI depends on a second parameter set means that the first field set in the first DCI refers to configuration of the second parameter set.

In one embodiment, that the indication of the first field set in the first DCI depends on a second parameter set means that at least one field in the first field set in the first DCI is used to indicate one parameter out of multiple parameters configured in the second parameter set.

In one embodiment, that the indication of the first field set in the first DCI depends on a second parameter set means that the interpretation of at least one field in the first field set in the first DCI refers to the second parameter set.

In one embodiment, that the indication of the first field set in the first DCI depends on a second parameter set means that the indication of each field in the first field set in the first DCI depends on at least one parameter in the second parameter set.

In one embodiment, that the indication of the first field set in the first DCI depends on a second parameter set means that the indication content of at least one field in the first field set in the first DCI depends on at least one parameter in the second parameter set.

In one embodiment, that the indication of the first field set in the first DCI depends on a second parameter set means that the indication method of at least one field in the first field set in the first DCI depends on at least one parameter in the second parameter set.

In one embodiment, that the indication of the first field set in the first DCI depends on a second parameter set means that the size of at least one field in the first field set in the first DCI depends on at least one parameter in the second parameter set.

In one embodiment, that the indication of the first field set in the first DCI depends on a second parameter set means that the presence of at least one field in the first field set in the first DCI depends on at least one parameter in the second parameter set.

In one embodiment, that the indication of the first field set in the first DCI depends on a second parameter set means that the indication of at least one field in the first field set in the first DCI is based on a table that depends on at least one parameter in the second parameter set.

In one embodiment, that the indication of the first field set in the first DCI depends on a second parameter set means that a field in the first field set in the first DCI indicates a value in a range of values, at least one parameter in the second parameter set being used to configure this range of values.

In one embodiment, that the indication of the first field set in the first DCI depends on a second parameter set means that what is indicated by a field in the first field set in the first DCI is indicated by a parameter in the second parameter set.

In one embodiment, that the indication of the first field set in the first DCI depends on a second parameter set means that the meaning of bit in at least one field in the first field set in the first DCI depends on at least one parameter in the second parameter set.

In one embodiment, that the indication of the first field set in the first DCI depends on a second parameter set means that what is indicated by the value of at least one field in the first field set in the first DCI depends on at least one parameter in the second parameter set.

In one embodiment, the expression depending on the second parameter set comprises: indicated by at least one parameter in the second parameter set or indicated jointly by multiple parameters including at least one parameter in the second parameter set.

In one embodiment, the expression depending on the second parameter set comprises: determined based on at least one parameter in the second parameter set.

In one embodiment, the expression depending on the second parameter set comprises: determined based on configuration information denoted by at least one parameter in the second parameter set.

In one embodiment, the expression depending on the second parameter set comprises: determined based on configuration information included by at least one parameter in the second parameter set.

In one embodiment, the expression depending on the second parameter set comprises: determined based on configuration information indicated by at least one parameter in the second parameter set.

In one embodiment, that the target cell is configured with the at least one first-type symbol means that the target cell is configured with the at least one first-type symbol by RRC signaling.

In one embodiment, that the target cell is configured with the at least one first-type symbol means that the target cell is configured with the at least one first-type symbol by higher layer signaling.

In one embodiment, that the target cell is configured with the at least one first-type symbol means that at least one symbol included in the target cell is configured as the first-type symbol.

In one embodiment, that the target cell is configured with the at least one first-type symbol means that at least one symbol included in the target cell is the first-type symbol.

In one embodiment, that the target cell is configured with the at least one first-type symbol means that there is one symbol in the target cell being the first-type symbol.

In one embodiment, that the target cell is configured with the at least one first-type symbol means that there is one symbol in the target cell being overlapping with the first-type symbol.

In one embodiment, that the target cell is configured with the at least one first-type symbol means that the target cell is a cell in the first cell set comprising the first-type symbols.

In one embodiment, that the target cell is not configured with the at least one first-type symbol means that there isn't any symbol in the target cell being configured as the first-type symbol.

In one embodiment, that the target cell is not configured with the at least one first-type symbol means that there isn't any symbol in the target cell being the first-type symbol.

In one embodiment, that the target cell is not configured with the at least one first-type symbol means that any symbol in the target cell is not the first-type symbol.

In one embodiment, that the target cell is not configured with the at least one first-type symbol means that any symbol in the target cell is orthogonal to the first-type symbol.

In one embodiment, multiple RRC signalings are respectively configured to multiple cells included in the first cell set: configurations of the multiple RRC signalings for each parameter in the first parameter set are identical, and configurations of the multiple RRC signalings for each parameter in the second parameter set are identical, the configurations for the first parameter set being different from the configurations for the second parameter set.

In one embodiment, multiple RRC signalings are respectively configured to multiple cells included in the first cell set: configurations of the multiple RRC signalings for each parameter in the first parameter set are respectively determined, and configurations of the multiple RRC signalings for each parameter in the second parameter set are respectively determined.

In one subembodiment, a first table comprises multiple candidates for the configurations of the multiple RRC signalings for the first parameter set, a field in the first field set in the first DCI being used to indicate a first parameter set from the first table: a second table comprises multiple candidates for the configurations of the multiple RRC signalings for the second parameter set, a field in the first field set in the first DCI being used to indicate a second parameter set from the second table.

In one subembodiment, the number of the multiple candidates for the configurations of the first parameter set is the same as the number of the multiple candidates for configurations of the second parameter set, and the number of bits included in one field in the first field set in the first DCI is dependent on the number of the multiple candidates.

In one embodiment, the number of parameters included in the first parameter set and the number of parameters included in the second parameter set are the same.

### Embodiment 8

Embodiment 8 illustrates a schematic diagram of an indication of a first field set according to another embodiment of the present application, as shown in FIG. 8.

In Embodiment 8, the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

In one embodiment, that the first symbol set comprises the at least one first-type symbol means that there is one symbol in the first symbol set being the first-type symbol.

In one embodiment, that the first symbol set comprises the at least one first-type symbol means that each symbol in the first symbol set is the first-type symbol.

In one embodiment, that the first symbol set comprises the at least one first-type symbol means that at least one symbol in the first symbol set is the first-type symbol.

In one embodiment, that the first symbol set comprises the at least one first-type symbol means that there is one symbol in the first symbol set overlapping with the first-type symbol.

In one embodiment, that the first symbol set comprises the at least one first-type symbol means that at least one symbol in the first symbol set overlaps with the first-type symbol.

In one embodiment, that the first symbol set does not comprise any one of the at least one first-type symbol means that there isn't any symbol in the first symbol set being the first-type symbol.

In one embodiment, that the first symbol set does not comprise any one of the at least one first-type symbol means that each symbol in the first symbol set is not the first-type symbol.

In one embodiment, that the first symbol set does not comprise any one of the at least one first-type symbol means that any symbol in the first symbol set is orthogonal to the first-type symbol.

In one embodiment, the third parameter set comprises only one parameter.

In one embodiment, the third parameter set comprises only multiple parameters.

In one embodiment, the third parameter set comprises one or more fields in a PDSCH-Config IE.

In one embodiment, the third parameter set comprises one or more fields in a PDSCH-ConfigCommon IE.

In one embodiment, the third parameter set comprises one or more fields in a PUSCH-Config IE.

In one embodiment, the third parameter set comprises one or more fields in a PUSCH-ConfigCommon IE.

In one embodiment, the third parameter set comprises one or more fields in an SRS-Config IE.

In one embodiment, the third parameter set comprises one or more fields in a PUCCH-config IE.

In one embodiment, the third parameter set comprises one or more fields in a PhysicalCellGroupConfig IE.

In one embodiment, the third parameter set comprises one or more fields in a BWP-Uplink IE.

In one embodiment, the third parameter set comprises one or more fields in a BWP-Downlink IE.

In one embodiment, one parameter in the third parameter set is a parameter configured by an RRC signaling.

In one embodiment, one parameter in the third parameter set is a parameter configured by a higher layer signaling.

In one embodiment, one parameter in the third parameter set is a configuration state.

In one embodiment, one parameter in the third parameter set denotes a configuration state.

In one embodiment, one parameter in the third parameter set includes a configuration state.

In one embodiment, one parameter in the third parameter set is used to indicate a configuration state.

In one embodiment, one parameter in the third parameter set is a configurable value.

In one embodiment, one parameter in the third parameter set is used to indicate a configurable value.

In one embodiment, the first field set in the first DCI comprises a Time Domain Resource Assignment field, and at least one parameter included in the third parameter set corresponds to pdsch-TimeDomainAllocationListDCI-x-y in a PDSCH-Config IE, where x-y corresponds to a DCI format of the first DCI.

In one embodiment, the first field set in the first DCI comprises a Time Domain Resource Assignment field, and at least one parameter included in the third parameter set corresponds to pdsch-TimeDomainAllocationListDCI-x-y in a PDSCH-ConfigCommon IE, where x-y corresponds to a DCI format of the first DCI.

In one embodiment, the first field set in the first DCI comprises a Time Domain Resource Assignment field, and at least one parameter included in the third parameter set corresponds to pusch-TimeDomainAllocationListDCI-x-y in a PUSCH-Config IE, where x-y corresponds to a DCI format of the first DCI.

In one embodiment, the first field set in the first DCI comprises a Time Domain Resource Assignment field, and at least one parameter included in the third parameter set corresponds to pusch-TimeDomainAllocationListDCI-x-y in a PUSCH-ConfigCommon IE, where x-y corresponds to a DCI format of the first DCI.

In one embodiment, the first field set in the first DCI comprises a VRB-to-PRB mapping field, and at least one parameter included in the third parameter set corresponds to vrb-ToPRB-InterleaverDCI-x-y in a PDSCH-Config IE, where x-y corresponds to a DCI format of the first DCI.

In one embodiment, the first field set in the first DCI comprises an Antenna port(s) field, and at least one parameter included in the third parameter set corresponds to antennaPortsFieldPresenceDCI-x-y in a PDSCH-config IE, where x-y corresponds to a DCI format of the first DCI.

In one embodiment, the first field set in the first DCI comprises an Antenna port(s) field, and at least one parameter included in the third parameter set corresponds to antennaPortsFieldPresenceDCI-x-y in a PUSCH-config IE, where x-y corresponds to a DCI format of the first DCI.

In one embodiment, the first field set in the first DCI comprises an Antenna port(s) field, and at least one parameter included in the third parameter set corresponds to antenna port(s) used by a signal scheduled by the first DCI.

In one embodiment, the first field set in the first DCI comprises a DMRS sequence initialization field, and at least one parameter included in the third parameter set corresponds to dmrs-SequenceInitializationDCI-x-y in a PDSCH-config IE, where x-y corresponds to a DCI format of the first DCI.

In one embodiment, the first field set in the first DCI comprises a DMRS sequence initialization field, and at least one parameter included in the third parameter set corresponds to dmrs-SequenceInitializationDCI-x-y in a PUSCH-config IE, where x-y corresponds to a DCI format of the first DCI.

In one embodiment, the first field set in the first DCI comprises a priority indicator field, and at least one parameter included in the third parameter set corresponds to priority IndicatorDCI-x-y in a PDSCH-config IE, where x-y corresponds to a DCI format of the first DCI.

In one embodiment, the first field set in the first DCI comprises a priority indicator field, and at least one parameter included in the third parameter set corresponds to priority IndicatorDCI-x-y in a PUSCH-config IE, where x-y corresponds to a DCI format of the first DCI.

In one embodiment, the first field set in the first DCI comprises a PRB bundling size indicator field, and at least one parameter included in the third parameter set corresponds to prb-Bundling TypeDCI-x-y in a PDSCH-config IE, where x-y corresponds to a DCI format of the first DCI.

In one embodiment, the first field set in the first DCI comprises an Enhanced Type 3 codebook indicator field, and at least one parameter included in the third parameter set corresponds to pdsch-HARQ-ACK-EnhType3DCI-x-y in a PDSCH-config IE, where x-y corresponds to a DCI format of the first DCI.

In one embodiment, the first field set in the first DCI comprises an Enhanced Type 3 codebook indicator field, and at least one parameter included in the third parameter set corresponds to pdsch-HARQ-ACK-EnhType3-rX in a PhysicalCellGroupConfig IE, where-rX indicates release version X.

In one embodiment, the first field set in the first DCI comprises a HARQ-ACK retransmission indicator field, and at least one parameter included in the third parameter set corresponds to pdsch-HARQ-ACK-RetxDCI-x-y in a PDSCH-config IE, where x-y corresponds to a DCI format of the first DCI.

In one embodiment, the first field set in the first DCI comprises a HARQ-ACK retransmission indicator field, and at least one parameter included in the third parameter set corresponds to pdsch-HARQ-ACK-Retx-rX in a PhysicalCellGroupConfig IE, where-rX indicates release version X.

In one embodiment, the first field set in the first DCI comprises a PUCCH Cell indicator field, and at least one parameter included in the third parameter set corresponds to pucch-sSCellDynDCI-x-y in a PDSCH-config IE, where x-y corresponds to a DCI format of the first DCI.

In one embodiment, the first field set in the first DCI comprises a PUCCH Cell indicator field, and at least one parameter included in the third parameter set corresponds to pucch-sSCellDyn-rX in a PhysicalCellGroupConfig IE, where-rX indicates release version X.

In one embodiment, the first field set in the first DCI comprises a Frequency hopping flag field, and at least one parameter included in the third parameter set corresponds to frequency HoppingDCI-x-y in a PUSCH-config IE, where x-y corresponds to a DCI format of the first DCI.

In one embodiment, the first field set in the first DCI comprises a Frequency hopping flag field, and at least one parameter included in the third parameter set corresponds to frequency HoppingOffsetListsDCI-x-y in a PUSCH-config IE, where x-y corresponds to a DCI format of the first DCI.

In one embodiment, the first field set in the first DCI comprises an SRS resource indicator field, and at least one parameter included in the third parameter set corresponds to srs-ResourceToAddModList in an SRS-Config IE.

In one embodiment, the first field set in the first DCI comprises a beta_offset indicator field, and at least one parameter included in the third parameter set corresponds to betaOffsetsCrossPri0DCI-x-y in a PUSCH-config IE, where x-y corresponds to a DCI format of the first DCI.

In one embodiment, the first field set in the first DCI comprises a beta_offset indicator field, and at least one parameter included in the third parameter set corresponds to betaOffsetsCrossPri1DCI-x-y in a PUSCH-config IE, where x-y corresponds to a DCI format of the first DCI.

In one embodiment, the first field set in the first DCI comprises a Bandwidth part indicator field, and at least one parameter included in the third parameter set corresponds to BWP-Id in a BWP-Uplink IE.

In one embodiment, the first field set in the first DCI comprises a Bandwidth part indicator field, and at least one parameter included in the third parameter set corresponds to BWP-Id in a BWP-Downlink IE.

In one embodiment, the first field set in the first DCI comprises a ChannelAccess-CPext field, and at least one parameter included in the third parameter set corresponds to ul-AccessConfigListDCI-x-y in a PUCCH-config IE, where x-y corresponds to a DCI format of the first DCI.

In one embodiment, the first field set in the first DCI comprises a ChannelAccess-CPext-CAPC field, and at least one parameter included in the third parameter set corresponds to ul-AccessConfigListDCI-x-y in a PUCCH-config IE, where x-y corresponds to a DCI format of the first DCI.

In one embodiment, the first field set in the first DCI comprises a field of Precoding information and number of layers, and at least one parameter included in the third parameter set corresponds to precoding AndNumberOfLayers in a ConfiguredGrantConfig IE.

In one embodiment, the first field set in the first DCI comprises a field of Open-loop power control parameter set indication, and at least one parameter included in the third parameter set corresponds to olpc-ParameterSetDCI-x-y in a PUSCH-PowerControl IE, where x-y corresponds to a DCI format of the first DCI.

In one embodiment, the first field set in the first DCI comprises an SRS request field, and at least one parameter included in the third parameter set corresponds to srs-RequestDCI-x-y in an SRS-Config IE, where x-y corresponds to a DCI format of the first DCI.

In one embodiment, the first field set in the first DCI comprises an SRS offset indicator field, and at least one parameter included in the third parameter set corresponds to AvailableSlotOffset-rX in an SRS-Config IE, where-rX indicates release version X.

In one embodiment, the first field set in the first DCI comprises a ZP CSI-RS trigger field, and at least one parameter included in the third parameter set corresponds to rateMatchPattern ToAddModList-rX in a PDSCH-Config IE, where-rX indicates release version X.

In one embodiment, the first field set in the first DCI comprises a Transmission configuration indication field, and at least one parameter included in the third parameter set corresponds to tci-PresentInDCI in a ControlResourceSet IE.

In one embodiment, the first field set in the first DCI comprises a Transmission configuration indication field, and at least one parameter included in the third parameter set corresponds to TCI-StateId in a TCI-State IE.

In one embodiment, the first field set in the first DCI comprises a Transmission configuration indication field, and at least one parameter included in the third parameter set corresponds to TCI-UL-StateId in a TCI-UL-State IE.

In one embodiment, the first field set in the first DCI comprises a field of TPC command for scheduled PUCCH, and at least one parameter included in the third parameter set corresponds to pucch-PowerControl in a PUCCH-Config IE.

In one embodiment, the first field set in the first DCI comprises a PDSCH-to-HARQ_feedback timing indicator field, and at least one parameter included in the third parameter set corresponds to dl-DataToUL-ACK-DCI-x-y in a PUCCH-Config IE, where x-y corresponds to a DCI format of the first DCI.

In one embodiment, the first field set in the first DCI comprises a Downlink assignment index field, and at least one parameter included in the third parameter set corresponds to pdsch-HARQ-ACK-Codebook-rX in a PhysicalCellGroupConfig IE, where-rX indicates release version X.

In one embodiment, the first field set in the first DCI comprises a PUCCH resource indicator field, and at least one parameter included in the third parameter set corresponds to resourceList in a PUCCH-Config IE.

In one embodiment, the first field set in the first DCI comprises a One-shot HARQ-ACK request field, and at least one parameter included in the third parameter set corresponds to pdsch-HARQ-ACK-OneShotFeedback DCI-x-y in a PDSCH-Config IE, where x-y corresponds to a DCI format of the first DCI.

In one embodiment, the first field set in the first DCI comprises a One-shot HARQ-ACK request field, and at least one parameter included in the third parameter set corresponds to pdsch-HARQ-ACK-OneShotFeedback-rX in a PhysicalCellGroupConfig IE, where-rX indicates release version X.

In one embodiment, the name of at least one parameter included in the third parameter set includes TimeDomainAllocation.

In one embodiment, the name of at least one parameter included in the third parameter set includes pdsch-TimeDomainAllocationList.

In one embodiment, the name of at least one parameter included in the third parameter set includes pusch-TimeDomainAllocationList.

In one embodiment, the name of at least one parameter included in the third parameter set includes vrb-ToPRB-Interleaver.

In one embodiment, the name of at least one parameter included in the third parameter set includes antennaPort.

In one embodiment, the name of at least one parameter included in the third parameter set includes dmrs-SequenceInitialization.

In one embodiment, the name of at least one parameter included in the third parameter set includes priority Indicator.

In one embodiment, the name of at least one parameter included in the third parameter set includes prb-Bundling Type.

In one embodiment, the name of at least one parameter included in the third parameter set includes pdsch-HARQ-ACK-EnhType3.

In one embodiment, the name of at least one parameter included in the third parameter set includes pdsch-HARQ-ACK-Retx.

In one embodiment, the name of at least one parameter included in the third parameter set includes pucch-sSCellDyn.

In one embodiment, the name of at least one parameter included in the third parameter set includes frequency Hopping.

In one embodiment, the name of at least one parameter included in the third parameter set includes frequency Hopping Offset.

In one embodiment, the name of at least one parameter included in the third parameter set includes srs-Resource.

In one embodiment, the name of at least one parameter included in the third parameter set includes betaOffsetsCrossPri0.

In one embodiment, the name of at least one parameter included in the third parameter set includes betaOffsetsCrossPri1.

In one embodiment, the name of at least one parameter included in the third parameter set includes bwp.

In one embodiment, the name of at least one parameter included in the third parameter set includes ul-AccessConfigList.

In one embodiment, the name of at least one parameter included in the third parameter set includes precoding AndNumberOfLayers.

In one embodiment, the name of at least one parameter included in the third parameter set includes olpc-ParameterSet.

In one embodiment, the name of at least one parameter included in the third parameter set includes srs-Request.

In one embodiment, the name of at least one parameter included in the third parameter set includes AvailableSlotOffset.

In one embodiment, the name of at least one parameter included in the third parameter set includes RateMatchPattern.

In one embodiment, the name of at least one parameter included in the third parameter set includes tci-PresentInDCI.

In one embodiment, the name of at least one parameter included in the third parameter set includes zp-CSI-RS-Resource.

In one embodiment, the name of at least one parameter included in the third parameter set includes TCI-State.

In one embodiment, the name of at least one parameter included in the third parameter set includes TCI-UL-State.

In one embodiment, the name of at least one parameter included in the third parameter set includes pucch-PowerControl.

In one embodiment, the name of at least one parameter included in the third parameter set includes dl-DataToUL-ACK.

In one embodiment, the name of at least one parameter included in the third parameter set includes pdsch-HARQ-ACK-Codebook.

In one embodiment, the name of at least one parameter included in the third parameter set includes resourceList.

In one embodiment, the name of at least one parameter included in the third parameter set includes pdsch-HARQ-ACK-OneShotFeedback.

In one embodiment, the name of at least one parameter included in the third parameter set includes-r18.

In one embodiment, the name of at least one parameter included in the third parameter set includes-r19.

In one embodiment, the name of at least one parameter included in the third parameter set includes-r20.

In one embodiment, that the indication of the first field set in the first DCI depends on a third parameter set means that the first field set in the first DCI refers to configuration of the third parameter set.

In one embodiment, that the indication of the first field set in the first DCI depends on a third parameter set means that at least one field in the first field set in the first DCI is used to indicate one parameter out of multiple parameters configured in the third parameter set.

In one embodiment, that the indication of the first field set in the first DCI depends on a third parameter set means that the interpretation of at least one field in the first field set in the first DCI refers to the third parameter set.

In one embodiment, that the indication of the first field set in the first DCI depends on a third parameter set means that the indication of each field in the first field set in the first DCI depends on at least one parameter in the third parameter set.

In one embodiment, that the indication of the first field set in the first DCI depends on a third parameter set means that the indication content of at least one field in the first field set in the first DCI depends on at least one parameter in the third parameter set.

In one embodiment, that the indication of the first field set in the first DCI depends on a third parameter set means that the indication method of at least one field in the first field set in the first DCI depends on at least one parameter in the third parameter set.

In one embodiment, that the indication of the first field set in the first DCI depends on a third parameter set means that the size of at least one field in the first field set in the first DCI depends on at least one parameter in the third parameter set.

In one embodiment, that the indication of the first field set in the first DCI depends on a third parameter set means that the presence of at least one field in the first field set in the first DCI depends on at least one parameter in the third parameter set.

In one embodiment, that the indication of the first field set in the first DCI depends on a third parameter set means that the indication of at least one field in the first field set in the first DCI is based on a table that depends on at least one parameter in the third parameter set.

In one embodiment, that the indication of the first field set in the first DCI depends on a third parameter set means that a field in the first field set in the first DCI indicates a value in a range of values, at least one parameter in the third parameter set being used to configure this range of values.

In one embodiment, that the indication of the first field set in the first DCI depends on a third parameter set means that what is indicated by a field in the first field set in the first DCI is indicated by a parameter in the third parameter set.

In one embodiment, that the indication of the first field set in the first DCI depends on a third parameter set means that the meaning of bit in at least one field in the first field set in the first DCI depends on at least one parameter in the third parameter set.

In one embodiment, that the indication of the first field set in the first DCI depends on a third parameter set means that what is indicated by the value of at least one field in the first field set in the first DCI depends on at least one parameter in the third parameter set.

In one embodiment, the expression depending on the third parameter set comprises: indicated by at least one parameter in the third parameter set or indicated jointly by multiple parameters including at least one parameter in the third parameter set.

In one embodiment, the expression depending on the third parameter set comprises: determined based on at least one parameter in the third parameter set.

In one embodiment, the expression depending on the third parameter set comprises: determined based on configuration information denoted by at least one parameter in the third parameter set.

In one embodiment, the expression depending on the third parameter set comprises: determined based on configuration information included by at least one parameter in the third parameter set.

In one embodiment, the expression depending on the third parameter set comprises: determined based on configuration information indicated by at least one parameter in the third parameter set.

In one embodiment, the fourth parameter set comprises only one parameter.

In one embodiment, the fourth parameter set comprises only multiple parameters.

In one embodiment, the fourth parameter set comprises one or more fields in a PDSCH-Config IE.

In one embodiment, the fourth parameter set comprises one or more fields in a PDSCH-ConfigCommon IE.

In one embodiment, the fourth parameter set comprises one or more fields in a PUSCH-Config IE.

In one embodiment, the fourth parameter set comprises one or more fields in a PUSCH-ConfigCommon IE.

In one embodiment, the fourth parameter set comprises one or more fields in an SRS-Config IE.

In one embodiment, the fourth parameter set comprises one or more fields in a PUCCH-config IE.

In one embodiment, the fourth parameter set comprises one or more fields in a PhysicalCellGroupConfig IE.

In one embodiment, the fourth parameter set comprises one or more fields in a BWP-Uplink IE.

In one embodiment, the fourth parameter set comprises one or more fields in a BWP-Downlink IE.

In one embodiment, one parameter in the fourth parameter set is a parameter configured by an RRC signaling.

In one embodiment, one parameter in the fourth parameter set is a parameter configured by a higher layer signaling.

In one embodiment, one parameter in the fourth parameter set is a configuration state.

In one embodiment, one parameter in the fourth parameter set denotes a configuration state.

In one embodiment, one parameter in the fourth parameter set includes a configuration state.

In one embodiment, one parameter in the fourth parameter set is used to indicate a configuration state.

In one embodiment, one parameter in the fourth parameter set is a configurable value.

In one embodiment, one parameter in the fourth parameter set is used to indicate a configurable value.

In one embodiment, the first field set in the first DCI comprises a Time Domain Resource Assignment field, and at least one parameter included in the fourth parameter set corresponds to pdsch-TimeDomainAllocationListDCI-x-y in a PDSCH-Config IE, where x-y corresponds to a DCI format of the first DCI.

In one embodiment, the first field set in the first DCI comprises a Time Domain Resource Assignment field, and at least one parameter included in the fourth parameter set corresponds to pdsch-TimeDomainAllocationListDCI-x-y in a PDSCH-ConfigCommon IE, where x-y corresponds to a DCI format of the first DCI.

In one embodiment, the first field set in the first DCI comprises a Time Domain Resource Assignment field, and at least one parameter included in the fourth parameter set corresponds to pusch-TimeDomainAllocationListDCI-x-y in a PUSCH-Config IE, where x-y corresponds to a DCI format of the first DCI.

In one embodiment, the first field set in the first DCI comprises a Time Domain Resource Assignment field, and at least one parameter included in the fourth parameter set corresponds to pusch-TimeDomainAllocationListDCI-x-y in a PUSCH-ConfigCommon IE, where x-y corresponds to a DCI format of the first DCI.

In one embodiment, the first field set in the first DCI comprises a VRB-to-PRB mapping field, and at least one parameter included in the fourth parameter set corresponds to vrb-ToPRB-InterleaverDCI-x-y in a PDSCH-Config IE, where x-y corresponds to a DCI format of the first DCI.

In one embodiment, the first field set in the first DCI comprises an Antenna port(s) field, and at least one parameter included in the fourth parameter set corresponds to antennaPortsFieldPresenceDCI-x-y in a PDSCH-config IE, where x-y corresponds to a DCI format of the first DCI.

In one embodiment, the first field set in the first DCI comprises an Antenna port(s) field, and at least one parameter included in the fourth parameter set corresponds to antennaPortsFieldPresenceDCI-x-y in a PUSCH-config IE, where x-y corresponds to a DCI format of the first DCI.

In one embodiment, the first field set in the first DCI comprises an Antenna port(s) field, and at least one parameter included in the fourth parameter set corresponds to antenna port(s) used by a signal scheduled by the first DCI.

In one embodiment, the first field set in the first DCI comprises a DMRS sequence initialization field, and at least one parameter included in the fourth parameter set corresponds to dmrs-SequenceInitializationDCI-x-y in a PDSCH-config IE, where x-y corresponds to a DCI format of the first DCI.

In one embodiment, the first field set in the first DCI comprises a DMRS sequence initialization field, and at least one parameter included in the fourth parameter set corresponds to dmrs-SequenceInitializationDCI-x-y in a PUSCH-config IE, where x-y corresponds to a DCI format of the first DCI.

In one embodiment, the first field set in the first DCI comprises a priority indicator field, and at least one parameter included in the fourth parameter set corresponds to priority IndicatorDCI-x-y in a PDSCH-config IE, where x-y corresponds to a DCI format of the first DCI.

In one embodiment, the first field set in the first DCI comprises a priority indicator field, and at least one parameter included in the fourth parameter set corresponds to priority IndicatorDCI-x-y in a PUSCH-config IE, where x-y corresponds to a DCI format of the first DCI.

In one embodiment, the first field set in the first DCI comprises a PRB bundling size indicator field, and at least one parameter included in the fourth parameter set corresponds to prb-Bundling TypeDCI-x-y in a PDSCH-config IE, where x-y corresponds to a DCI format of the first DCI.

In one embodiment, the first field set in the first DCI comprises an Enhanced Type 3 codebook indicator field, and at least one parameter included in the fourth parameter set corresponds to pdsch-HARQ-ACK-EnhType3DCI-x-y in a PDSCH-config IE, where x-y corresponds to a DCI format of the first DCI.

In one embodiment, the first field set in the first DCI comprises an Enhanced Type 3 codebook indicator field, and at least one parameter included in the fourth parameter set corresponds to pdsch-HARQ-ACK-EnhType3-rX in a PhysicalCellGroupConfig IE, where-rX indicates release version X.

In one embodiment, the first field set in the first DCI comprises a HARQ-ACK retransmission indicator field, and at least one parameter included in the fourth parameter set corresponds to pdsch-HARQ-ACK-RetxDCI-x-y in a PDSCH-config IE, where x-y corresponds to a DCI format of the first DCI.

In one embodiment, the first field set in the first DCI comprises a HARQ-ACK retransmission indicator field, and at least one parameter included in the fourth parameter set corresponds to pdsch-HARQ-ACK-Retx-rX in a PhysicalCellGroupConfig IE, where-rX indicates release version X.

In one embodiment, the first field set in the first DCI comprises a PUCCH Cell indicator field, and at least one parameter included in the fourth parameter set corresponds to pucch-sSCellDynDCI-x-y in a PDSCH-config IE, where x-y corresponds to a DCI format of the first DCI.

In one embodiment, the first field set in the first DCI comprises a PUCCH Cell indicator field, and at least one parameter included in the fourth parameter set corresponds to pucch-sSCellDyn-rX in a PhysicalCellGroupConfig IE, where-rX indicates release version X.

In one embodiment, the first field set in the first DCI comprises a Frequency hopping flag field, and at least one parameter included in the fourth parameter set corresponds to frequency HoppingDCI-x-y in a PUSCH-config IE, where x-y corresponds to a DCI format of the first DCI.

In one embodiment, the first field set in the first DCI comprises a Frequency hopping flag field, and at least one parameter included in the fourth parameter set corresponds to frequency HoppingOffsetListsDCI-x-y in a PUSCH-config IE, where x-y corresponds to a DCI format of the first DCI.

In one embodiment, the first field set in the first DCI comprises an SRS resource indicator field, and at least one parameter included in the fourth parameter set corresponds to srs-ResourceToAddModList in an SRS-Config IE.

In one embodiment, the first field set in the first DCI comprises a beta_offset indicator field, and at least one parameter included in the fourth parameter set corresponds to betaOffsetsCrossPri0DCI-x-y in a PUSCH-config IE, where x-y corresponds to a DCI format of the first DCI.

In one embodiment, the first field set in the first DCI comprises a beta_offset indicator field, and at least one parameter included in the fourth parameter set corresponds to betaOffsetsCrossPri1DCI-x-y in a PUSCH-config IE, where x-y corresponds to a DCI format of the first DCI.

In one embodiment, the first field set in the first DCI comprises a Bandwidth part indicator field, and at least one parameter included in the fourth parameter set corresponds to BWP-Id in a BWP-Uplink IE.

In one embodiment, the first field set in the first DCI comprises a Bandwidth part indicator field, and at least one parameter included in the fourth parameter set corresponds to BWP-Id in a BWP-Downlink IE.

In one embodiment, the first field set in the first DCI comprises a ChannelAccess-CPext field, and at least one parameter included in the fourth parameter set corresponds to ul-AccessConfigListDCI-x-y in a PUCCH-config IE, where x-y corresponds to a DCI format of the first DCI.

In one embodiment, the first field set in the first DCI comprises a ChannelAccess-CPext-CAPC field, and at least one parameter included in the fourth parameter set corresponds to ul-AccessConfigListDCI-x-y in a PUCCH-config IE, where x-y corresponds to a DCI format of the first DCI.

In one embodiment, the first field set in the first DCI comprises a field of Precoding information and number of layers, and at least one parameter included in the fourth parameter set corresponds to precoding AndNumberOfLayers in a ConfiguredGrantConfig IE.

In one embodiment, the first field set in the first DCI comprises a field of Open-loop power control parameter set indication, and at least one parameter included in the fourth parameter set corresponds to olpc-ParameterSetDCI-x-y in a PUSCH-PowerControl IE, where x-y corresponds to a DCI format of the first DCI.

In one embodiment, the first field set in the first DCI comprises an SRS request field, and at least one parameter included in the fourth parameter set corresponds to srs-RequestDCI-x-y in an SRS-Config IE, where x-y corresponds to a DCI format of the first DCI.

In one embodiment, the first field set in the first DCI comprises an SRS offset indicator field, and at least one parameter included in the fourth parameter set corresponds to AvailableSlotOffset-rX in an SRS-Config IE, where-rX indicates release version X.

In one embodiment, the first field set in the first DCI comprises a ZP CSI-RS trigger field, and at least one parameter included in the fourth parameter set corresponds to rateMatchPatternToAddModList-rX in a PDSCH-Config IE, where-rX indicates release version X.

In one embodiment, the first field set in the first DCI comprises a Transmission configuration indication field, and at least one parameter included in the fourth parameter set corresponds to tei-PresentInDCI in a ControlResourceSet IE.

In one embodiment, the first field set in the first DCI comprises a Transmission configuration indication field, and at least one parameter included in the fourth parameter set corresponds to TCI-StateId in a TCI-State IE.

In one embodiment, the first field set in the first DCI comprises a Transmission configuration indication field, and at least one parameter included in the fourth parameter set corresponds to TCI-UL-StateId in a TCI-UL-State IE.

In one embodiment, the first field set in the first DCI comprises a field of TPC command for scheduled PUCCH, and at least one parameter included in the fourth parameter set corresponds to pucch-PowerControl in a PUCCH-Config IE.

In one embodiment, the first field set in the first DCI comprises a PDSCH-to-HARQ_feedback timing indicator field, and at least one parameter included in the fourth parameter set corresponds to dl-DataToUL-ACK-DCI-x-y in a PUCCH-Config IE, where x-y corresponds to a DCI format of the first DCI.

In one embodiment, the first field set in the first DCI comprises a Downlink assignment index field, and at least one parameter included in the fourth parameter set corresponds to pdsch-HARQ-ACK-Codebook-rX in a PhysicalCellGroupConfig IE, where-rX indicates release version X.

In one embodiment, the first field set in the first DCI comprises a PUCCH resource indicator field, and at least one parameter included in the fourth parameter set corresponds to resourceList in a PUCCH-Config IE.

In one embodiment, the first field set in the first DCI comprises a One-shot HARQ-ACK request field, and at least one parameter included in the fourth parameter set corresponds to pdsch-HARQ-ACK-OneShotFeedback DCI-x-y in a PDSCH-Config IE, where x-y corresponds to a DCI format of the first DCI.

In one embodiment, the first field set in the first DCI comprises a One-shot HARQ-ACK request field, and at least one parameter included in the fourth parameter set corresponds to pdsch-HARQ-ACK-OneShotFeedback-rX in a PhysicalCellGroupConfig IE, where-rX indicates release version X.

In one embodiment, the name of at least one parameter included in the fourth parameter set includes TimeDomainAllocation.

In one embodiment, the name of at least one parameter included in the fourth parameter set includes pdsch-TimeDomainAllocationList.

In one embodiment, the name of at least one parameter included in the fourth parameter set includes pusch-TimeDomainAllocationList.

In one embodiment, the name of at least one parameter included in the fourth parameter set includes vrb-ToPRB-Interleaver.

In one embodiment, the name of at least one parameter included in the fourth parameter set includes antennaPort.

In one embodiment, the name of at least one parameter included in the fourth parameter set includes dmrs-SequenceInitialization.

In one embodiment, the name of at least one parameter included in the fourth parameter set includes priority Indicator.

In one embodiment, the name of at least one parameter included in the fourth parameter set includes prb-Bundling Type.

In one embodiment, the name of at least one parameter included in the fourth parameter set includes pdsch-HARQ-ACK-EnhType3.

In one embodiment, the name of at least one parameter included in the fourth parameter set includes pdsch-HARQ-ACK-Retx.

In one embodiment, the name of at least one parameter included in the fourth parameter set includes pucch-sSCellDyn.

In one embodiment, the name of at least one parameter included in the fourth parameter set includes frequency Hopping.

In one embodiment, the name of at least one parameter included in the fourth parameter set includes requencyHoppingOffset.

In one embodiment, the name of at least one parameter included in the fourth parameter set includes srs-Resource.

In one embodiment, the name of at least one parameter included in the fourth parameter set includes betaOffsetsCrossPri0.

In one embodiment, the name of at least one parameter included in the fourth parameter set includes betaOffsetsCrossPri1.

In one embodiment, the name of at least one parameter included in the fourth parameter set includes bwp.

In one embodiment, the name of at least one parameter included in the fourth parameter set includes ul-AccessConfigList.

In one embodiment, the name of at least one parameter included in the fourth parameter set includes precoding AndNumberOfLayers.

In one embodiment, the name of at least one parameter included in the fourth parameter set includes olpc-ParameterSet.

In one embodiment, the name of at least one parameter included in the fourth parameter set includes srs-Request.

In one embodiment, the name of at least one parameter included in the fourth parameter set includes AvailableSlotOffset.

In one embodiment, the name of at least one parameter included in the fourth parameter set includes RateMatchPattern.

In one embodiment, the name of at least one parameter included in the fourth parameter set includes tci-PresentInDCI.

In one embodiment, the name of at least one parameter included in the fourth parameter set includes zp-CSI-RS-Resource.

In one embodiment, the name of at least one parameter included in the fourth parameter set includes TCI-State.

In one embodiment, the name of at least one parameter included in the fourth parameter set includes TCI-UL-State.

In one embodiment, the name of at least one parameter included in the fourth parameter set includes pucch-PowerControl.

In one embodiment, the name of at least one parameter included in the fourth parameter set includes dl-DataToUL-ACK.

In one embodiment, the name of at least one parameter included in the fourth parameter set includes pdsch-HARQ-ACK-Codebook.

In one embodiment, the name of at least one parameter included in the fourth parameter set includes resourceList.

In one embodiment, the name of at least one parameter included in the fourth parameter set includes pdsch-HARQ-ACK-OneShotFeedback.

In one embodiment, the name of at least one parameter included in the fourth parameter set includes-r18.

In one embodiment, the name of at least one parameter included in the fourth parameter set includes-r19.

In one embodiment, the name of at least one parameter included in the fourth parameter set includes-r20.

In one embodiment, that the indication of the first field set in the first DCI depends on a fourth parameter set means that the indication of each field in the first field set in the first DCI depends on at least one parameter in the fourth parameter set.

In one embodiment, that the indication of the first field set in the first DCI depends on a fourth parameter set means that the indication content of at least one field in the first field set in the first DCI depends on at least one parameter in the fourth parameter set.

In one embodiment, that the indication of the first field set in the first DCI depends on a fourth parameter set means that the indication method of at least one field in the first field set in the first DCI depends on at least one parameter in the fourth parameter set.

In one embodiment, that the indication of the first field set in the first DCI depends on a fourth parameter set means that the size of at least one field in the first field set in the first DCI depends on at least one parameter in the fourth parameter set.

In one embodiment, that the indication of the first field set in the first DCI depends on a fourth parameter set means that the presence of at least one field in the first field set in the first DCI depends on at least one parameter in the fourth parameter set.

In one embodiment, that the indication of the first field set in the first DCI depends on a fourth parameter set means that the indication of at least one field in the first field set in the first DCI is based on a table that depends on at least one parameter in the fourth parameter set.

In one embodiment, that the indication of the first field set in the first DCI depends on a fourth parameter set means that a field in the first field set in the first DCI indicates a value in a range of values, at least one parameter in the fourth parameter set being used to configure this range of values.

In one embodiment, that the indication of the first field set in the first DCI depends on a fourth parameter set means that what is indicated by a field in the first field set in the first DCI is indicated by a parameter in the fourth parameter set.

In one embodiment, that the indication of the first field set in the first DCI depends on a fourth parameter set means that the meaning of bit in at least one field in the first field set in the first DCI depends on at least one parameter in the fourth parameter set.

In one embodiment, that the indication of the first field set in the first DCI depends on a fourth parameter set means that what is indicated by the value of at least one field in the first field set in the first DCI depends on at least one parameter in the fourth parameter set.

In one embodiment, the expression depending on the fourth parameter set comprises: indicated by at least one parameter in the fourth parameter set or indicated jointly by multiple parameters including at least one parameter in the fourth parameter set.

In one embodiment, the expression depending on the fourth parameter set comprises: determined based on at least one parameter in the fourth parameter set.

In one embodiment, the expression depending on the fourth parameter set comprises: determined based on configuration information denoted by at least one parameter in the fourth parameter set.

In one embodiment, the expression depending on the fourth parameter set comprises: determined based on configuration information included by at least one parameter in the fourth parameter set.

In one embodiment, the expression depending on the fourth parameter set comprises: determined based on configuration information indicated by at least one parameter in the fourth parameter set.

In one embodiment, multiple RRC signalings are respectively configured to multiple cells included in the first cell set: configurations of the multiple RRC signalings for each parameter in the third parameter set are identical, and configurations of the multiple RRC signalings for each parameter in the fourth parameter set are identical, the configurations for the third parameter set being different from the configurations for the fourth parameter set.

In one embodiment, multiple RRC signalings are respectively configured to multiple cells included in the first cell set: configurations of the multiple RRC signalings for each parameter in the third parameter set are respectively determined, and configurations of the multiple RRC signalings for each parameter in the fourth parameter set are respectively determined.

In one embodiment, the number of parameters included in the third parameter set and the number of parameters included in the fourth parameter set are the same.

### Embodiment 9

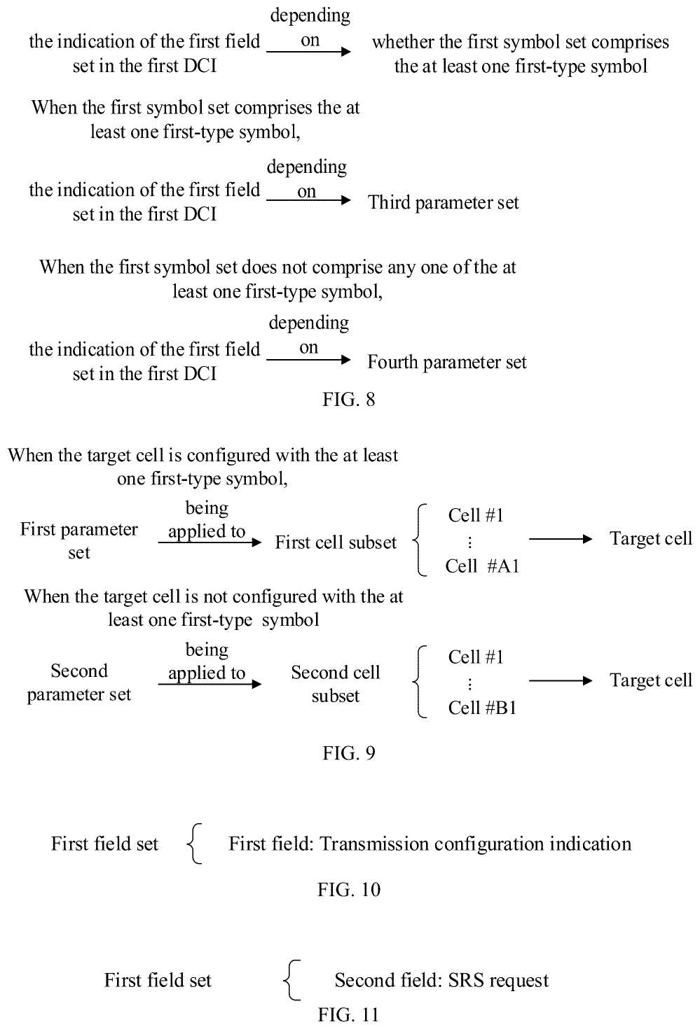

Embodiment 9 illustrates a schematic diagram of relations among a target cell, a first cell subset and a second cell subset according to one embodiment of the present application, as shown in FIG. 9. In FIG. 9, the first cell subset comprises A1 cells, where a target cell is a cell in the first cell subset when the target cell is configured with the at least one first-type symbol: the second cell subset comprises BI cells, where a target cell is a cell in the second cell subset when the target cell is not configured with the at least one first-type symbol.

In Embodiment 9, when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset; the first cell subset comprises multiple cells, and the second cell subset comprises multiple cells.

In one embodiment, the first cell set comprises the first cell subset.

In one embodiment, the first cell set comprises the second cell subset.

In one embodiment, the first cell set comprises the first cell subset and the second cell subset.

In one embodiment, the first cell set consists of the first cell subset and the second cell subset.

In one embodiment, the first cell subset comprises only one cell.

In one embodiment, the first cell subset comprises at least one cell.

In one embodiment, the second cell subset comprises only one cell.

In one embodiment, the second cell subset comprises at least one cell.

In one embodiment, “the first parameter set being applied to the first cell subset” means that the first parameter set configures the first cell subset.

In one embodiment, “the first parameter set being applied to the first cell subset” means that the first parameter set indicates the first cell subset.

In one embodiment, “the first parameter set being applied to the first cell subset” means that each parameter included in the first parameter set is applied to the first cell subset.

In one embodiment, “the first parameter set being applied to the first cell subset” means that at least one parameter included in the first parameter set is applied to the first cell subset.

In one embodiment, “the first parameter set being applied to the first cell subset” means that the value of at least one parameter included in the first parameter set is applied to the first cell subset.

In one embodiment, “the first parameter set being applied to the first cell subset” means that the configuration of at least one parameter included in the first parameter set is applied to the first cell subset.

In one embodiment, “being applied to the first cell subset” means being applied to a PUSCH transmitted on the first cell subset.

In one embodiment, “being applied to the first cell subset” means being applied to a PDSCH received on the first cell subset.

In one embodiment, “being applied to the first cell subset” means being applied to a signal being transmitted on the first cell subset.

In one embodiment, “the second parameter set being applied to the second cell subset” means that the second parameter set configures the second cell subset.

In one embodiment, “the second parameter set being applied to the second cell subset” means that the second parameter set indicates the second cell subset.

In one embodiment, “the second parameter set being applied to the second cell subset” means that each parameter included in the second parameter set is applied to the second cell subset.

In one embodiment, “the second parameter set being applied to the second cell subset” means that at least one parameter included in the second parameter set is applied to the second cell subset.

In one embodiment, “the second parameter set being applied to the second cell subset” means that the value of at least one parameter included in the second parameter set is applied to the second cell subset.

In one embodiment, “the second parameter set being applied to the second cell subset” means that the configuration of at least one parameter included in the second parameter set is applied to the second cell subset.

In one embodiment, “being applied to the second cell subset” means being applied to a PUSCH transmitted on the second cell subset.

In one embodiment, “being applied to the second cell subset” means being applied to a PDSCH received on the second cell subset.

In one embodiment, “being applied to the second cell subset” means being applied to a signal being transmitted on the second cell subset.

In one embodiment, a first RRC signaling set is configured to the first cell subset, and a second RRC signaling set is configured to the second cell subset: configurations of the first RRC signaling set for the first parameter set are identical, and configurations of the second RRC signaling set for the second parameter set are identical, the configurations of the first parameter set being different from the configurations of the second parameter set.

In one embodiment, “configurations of the first RRC signaling set for the first parameter set are identical” means that multiple signalings included in the first RRC signaling set are respectively for multiple parameters included in the first parameter set, the multiple parameters included in the first parameter set corresponding to fields having the same name.

In one embodiment, “configurations of the first RRC signaling set for the first parameter set are identical” means that multiple signalings included in the first RRC signaling set are respectively for multiple parameters included in the first parameter set, the multiple parameters included in the first parameter set corresponding to the same field.

In one embodiment, “configurations of the first RRC signaling set for the first parameter set are identical” means that multiple signalings included in the first RRC signaling set are respectively for multiple parameters included in the first parameter set, the multiple parameters included in the first parameter set having the same value.

In one embodiment, “configurations of the first RRC signaling set for the first parameter set are identical” means that multiple signalings included in the first RRC signaling set are respectively for multiple parameters included in the first parameter set, the multiple parameters included in the first parameter set having the same configuration.

In one embodiment, “configurations of the second RRC signaling set for the second parameter set are identical” means that multiple signalings included in the second RRC signaling set are respectively for multiple parameters included in the second parameter set, the multiple parameters included in the second parameter set corresponding to fields having the same name.

In one embodiment, “configurations of the second RRC signaling set for the second parameter set are identical” means that multiple signalings included in the second RRC signaling set are respectively for multiple parameters included in the second parameter set, the multiple parameters included in the second parameter set corresponding to the same field.

In one embodiment, “configurations of the second RRC signaling set for the second parameter set are identical” means that multiple signalings included in the second RRC signaling set are respectively for multiple parameters included in the second parameter set, the multiple parameters included in the second parameter set having the same value.

In one embodiment, “configurations of the second RRC signaling set for the second parameter set are identical” means that multiple signalings included in the second RRC signaling set are respectively for multiple parameters included in the second parameter set, the multiple parameters included in the second parameter set having the same configuration.

### Embodiment 10

Embodiment 10 illustrates a schematic diagram of fields included in a first field set according to one embodiment of the present application, as shown in FIG. 10.

In Embodiment 10, the first field set comprises a first field, the first field being a Transmission configuration indication.

In one embodiment, the first field of the first field set is dependent on the first parameter.

In one embodiment, the presence or absence of the first field of the first field set is dependent on the first parameter.

In one embodiment, an indication of the first field of the first field set is dependent on the first parameter.

In one embodiment, the first field of the first field set is in reference to configuration of the first parameter.

In one embodiment, the first field of the first field set is interpreted in reference to the first parameter.

In one embodiment, the first parameter is used to determine whether the first field exists or not.

In one embodiment, the first parameter is used to determine a spatial parameter of a signal scheduled by the first DCI.

In one embodiment, the first parameter comprises a tci-PresentInDCI in a ControlResourceSet IE.

In one embodiment, the first parameter comprises a TCI-StateId in a TCI-State IE.

In one embodiment, the first parameter comprises a TCI-UL-StateId in a TCI-UL-State IE.

In one embodiment, the first parameter includes TCI in its name.

In one embodiment, the number of bits included in the first field of the first field set is at most 4.

### Embodiment 11

Embodiment 11 illustrates a schematic diagram of fields included in a first field set according to another embodiment of the present application, as shown in FIG. 11.

In Embodiment 11, the first field set comprises a second field, the second field being an SRS request.

In one embodiment, the second field of the first field set is dependent on the second parameter.

In one embodiment, an indication of the second field of the first field set is dependent on the second parameter.

In one embodiment, the second field of the first field set is configured in reference to the second parameter.

In one embodiment, the second field of the first field set is interpreted in reference to the second parameter.

In one embodiment, the second parameter is used to trigger an aperiodic Sounding Reference Signal (SRS) resource.

In one embodiment, the second parameter is used to trigger transmission of a Sounding Reference Signal (SRS) resource.

In one embodiment, the second parameter comprises srs-RequestDCI-x-y in an SRS-Config IE, where x-y corresponds to the DCI format of the first DCI.

In one embodiment, a name of the second parameter includes srs-Request.

In one embodiment, the number of bits included in the second field of the first field set is at most 4.

### Embodiment 12

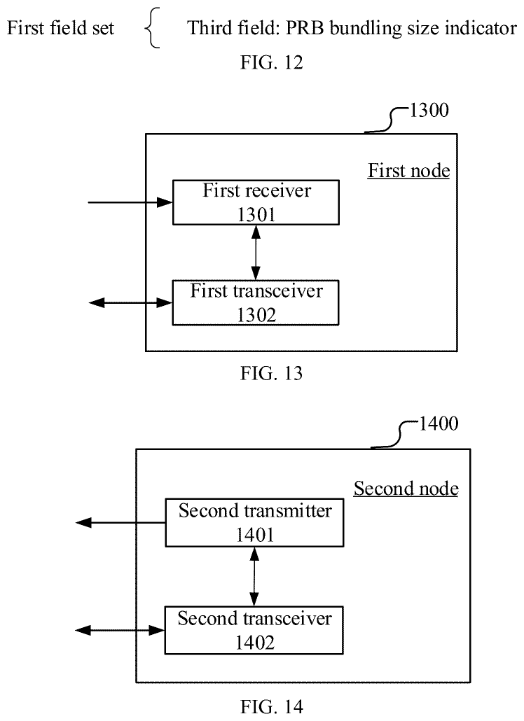

Embodiment 12 illustrates a schematic diagram of fields included in a first field set according to a third embodiment of the present application, as shown in FIG. 12.

In Embodiment 12, the first field set comprises a third field, the third field being a PRB bundling size indicator.

In one embodiment, the third field of the first field set is dependent on the third parameter.

In one embodiment, an indication of the third field of the first field set is dependent on the third parameter.

In one embodiment, the third field of the first field set is configured in reference to the third parameter.

In one embodiment, the third field of the first field set is interpreted in reference to the third parameter.

In one embodiment, the third parameter is used to indicate a manner of PRB bundling.

In one embodiment, the third parameter is used to indicate a size of PRB bundling.

In one embodiment, the third parameter comprises prb-BundlingTypeDCI-x-y in a PDSCH-config IE, where x-y corresponds to the DCI format of the first DCI.

In one embodiment, the second parameter includes prb-Bundling Type in its name.

### Embodiment 13

Embodiment 13 illustrates a structure block diagram of a processing device used in a first node according to one embodiment of the present application, as shown in FIG. 13. In FIG. 13, a processing device 1300 in a first node is comprised of a first receiver 1301 and a first transceiver 1302.

In one embodiment, the first node is a UE.

In one embodiment, the first node is a relay node.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transceiver 1302 comprises at least one of the antenna 452, the receiver/transmitter 454, the receiving processor 456, the transmitting processor 468, the multi-antenna receiving processor 458, the multi-antenna transmitting processor 457, the controller/processor 459, the memory 460 or the data source 467 in Embodiment 4.

The first receiver 1301 receives a first DCI:
the first transceiver 1302 receives or transmits a first radio signal in the K1 cells.

In Embodiment 13, the first DCI schedules a first cell set, the first cell set comprising K1 cells: the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol; the first-type symbol includes a symbol for uplink that is configured as downlink symbol by TDD UL-DL configuration signaling.

In one embodiment, an indication of the first field set in the first DCI is dependent on whether the target cell is configured with at least one first-type symbol.

In one embodiment, an indication of the first field set in the first DCI is dependent on whether the first symbol set comprises at least one first-type symbol.

In one embodiment, the indication of the first field set in the first DCI depends on whether the target cell is configured with at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

In one embodiment, the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

In one embodiment, when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset: the first cell subset comprises multiple cells, and the second cell subset comprises multiple cells.

In one embodiment, the first field set comprises a first field, the first field being a Transmission configuration indication.

In one embodiment, the first field set comprises a second field, the second field being an SRS request.

In one embodiment, the first field set comprises a third field, the third field being a PRB bundling size indicator.

### Embodiment 14

Embodiment 14 illustrates a structure block diagram of a processing device used in a second node according to one embodiment of the present application, as shown in FIG. 14. In FIG. 14, a processing device 1400 in a second node is comprised of a second transmitter 1401 and a second transceiver 1402.

In one embodiment, the second node is a base station.

In one embodiment, the second node is a UE.

In one embodiment, the second node is a relay node.

In one embodiment, the second transmitter 1401 comprises at least one of the antenna 420, the transmitter 418, the transmitting processor 416, the multi-antenna transmitting processor 471, the controller/processor 475 or the memory 476 in Embodiment 4.

In one embodiment, the second transceiver 1402 comprises at least one of the antenna 420, the receiver/transmitter 418, the receiving processor 470, the transmitting processor 416, the multi-antenna receiving processor 472, the multi-antenna transmitting processor 471, the controller/processor 475 or the memory 476 in Embodiment 4.

The second transmitter 1401 transmits a first DCI:
the second transceiver 1402 transmits or receives a first radio signal in the K1 cells.

In Embodiment 14, the first DCI schedules a first cell set, the first cell set comprising K1 cells; the first DCI indicates a first symbol set, the first radio signal occupying the first symbol set in time domain; a first field set in the first DCI is applied to a target cell in the first cell set; an indication of the first field set in the first DCI depends on whether the target cell is configured with at least one first-type symbol, or the indication of the first field set in the first DCI depends on whether the first symbol set comprises at least one first-type symbol; the first-type symbol includes a symbol for uplink that is configured as downlink symbol by TDD UL-DL configuration signaling.

In one embodiment, an indication of the first field set in the first DCI is dependent on whether the target cell is configured with at least one first-type symbol.

In one embodiment, an indication of the first field set in the first DCI is dependent on whether the first symbol set comprises at least one first-type symbol.

In one embodiment, the indication of the first field set in the first DCI depends on whether the target cell is configured with at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

In one embodiment, the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

In one embodiment, when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset: the first cell subset comprises multiple cells, and the second cell subset comprises multiple cells.

In one embodiment, the first field set comprises a first field, the first field being a Transmission configuration indication.

In one embodiment, the first field set comprises a second field, the second field being an SRS request.

In one embodiment, the first field set comprises a third field, the third field being a PRB bundling size indicator.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any change or modification made based on the embodiments described in this specification, if, through which similar partial or all technical effects can be obtained, shall be considered apparent and fall within the scope of protection of the present invention.

What is claimed is:

1. A first node for wireless communications, comprising:
a first receiver, receiving a first DCI, the first DCI scheduling a first cell set, the first cell set comprising K1 cells; and
a first transmitter, receiving or transmitting a first radio signal in the K1 cells;
wherein the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

2. The first node according to claim 1, characterized in that the indication of the first field set in the first DCI depends on whether the target cell is configured with the at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

3. The first node according to claim 1, characterized in that the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

4. The first node according to claim 2, characterized in that when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset: the first cell subset comprises multiple cells, and the second cell subset comprises multiple cells.

5. The first node according to claim 1, characterized in that the first field set comprises a first field, the first field being a Transmission configuration indication.

6. The first node according to claim 1, characterized in that the first field set comprises a second field, the second field being an SRS request.

7. The first node according to claim 1, characterized in that the first field set comprises a third field, the third field being a PRB bundling size indicator.

8. The first node according to claim 1, characterized in that the first parameter set comprises one or more fields in a PDSCH-Config IE, or the first parameter set comprises one or more fields in a PDSCH-ConfigCommon IE, or the first parameter set comprises one or more fields in a PUSCH-Config IE, or the first parameter set comprises one or more fields in a PUSCH-ConfigCommon IE.

9. The first node according to claim 1, characterized in that the second parameter set comprises one or more fields in a PDSCH-Config IE, or the second parameter set comprises one or more fields in a PDSCH-ConfigCommon IE, or the second parameter set comprises one or more fields in a PUSCH-Config IE, or the second parameter set comprises one or more fields in a PUSCH-ConfigCommon IE.

10. The first node according to claim 1, characterized in that the third parameter set comprises one or more fields in a PDSCH-Config IE, or the third parameter set comprises one or more fields in a PDSCH-ConfigCommon IE, or the third parameter set comprises one or more fields in a PUSCH-Config IE, or the third parameter set comprises one or more fields in a PUSCH-ConfigCommon IE.

11. The first node according to claim 1, characterized in that the fourth parameter set comprises one or more fields in a PDSCH-Config IE, or the fourth parameter set comprises one or more fields in a PDSCH-ConfigCommon IE, or the fourth parameter set comprises one or more fields in a PUSCH-Config IE, or the fourth parameter set comprises one or more fields in a PUSCH-ConfigCommon IE.

12. The first node according to claim 2, characterized in that multiple RRC signalings are respectively configured to multiple cells included in the first cell set: configurations of the multiple RRC signalings for each parameter in the first parameter set are respectively determined, and configurations of the multiple RRC signalings for each parameter in the second parameter set are respectively determined.

13. The first node according to claim 3, characterized in that multiple RRC signalings are respectively configured to multiple cells included in the first cell set: configurations of the multiple RRC signalings for each parameter in the third parameter set are identical, and configurations of the multiple RRC signalings for each parameter in the fourth parameter set are identical, the configurations for the third parameter set being different from the configurations for the fourth parameter set.

14. The first node according to claim 3, characterized in that multiple RRC signalings are respectively configured to multiple cells included in the first cell set: configurations of the multiple RRC signalings for each parameter in the third parameter set are respectively determined, and configurations of the multiple RRC signalings for each parameter in the fourth parameter set are respectively determined.

15. A second node for wireless communications, comprising:
a second transmitter, transmitting a first DCI, the first DCI scheduling a first cell set, the first cell set comprising K1 cells; and
a second transceiver, transmitting or receiving a first radio signal in the K1 cells;
wherein the first DCI indicates a first symbol set, the first radio signal occupying the first symbol set in time domain: a first field set in the first DCI is applied to a target cell in the first cell set: an indication of the first field set in the first DCI depends on whether the target cell is configured with at least one first-type symbol, or the indication of the first field set in the first DCI depends on whether the first symbol set comprises at least one first-type symbol: the first-type symbol includes a symbol for uplink that is configured as downlink symbol by TDD UL-DL configuration signaling.

16. The second node according to claim 15, characterized in that the indication of the first field set in the first DCI depends on whether the target cell is configured with the at least one first-type symbol: when the target cell is configured with the at least one first-type symbol, the indication of the first field set in the first DCI depends on a first parameter set: when the target cell is not configured with the at least one first-type symbol, the indication of the first field set in the first DCI depends on a second parameter set.

17. The second node according to claim 15, characterized in that the indication of the first field set in the first DCI depends on whether the first symbol set comprises the at least one first-type symbol: when the first symbol set comprises the at least one first-type symbol, the indication of the first field set in the first DCI depends on a third parameter set: when the first symbol set does not comprise any one of the at least one first-type symbol, the indication of the first field set in the first DCI depends on a fourth parameter set.

18. The second node according to claim 16, characterized in that when the target cell is configured with the at least one first-type symbol, the target cell is a cell in a first cell subset, the first parameter set being applied to the first cell subset: when the target cell is not configured with the at least one first-type symbol, the target cell is a cell in a second cell subset, the second parameter set being applied to the second cell subset: the first cell subset comprises multiple cells, and the second cell subset comprises multiple cells.

19. The second node according to claim 15, characterized in that the first field set comprises at least one of:
a first field, the first field being a Transmission configuration indication: or
a second field, the second field being an SRS request: or
a third field, the third field being a PRB bundling size indicator.

20. A method in a first node for wireless communications, comprising:
receiving a first DCI, the first DCI scheduling a first cell set, the first cell set comprising K1 cells; and
receiving or transmitting a first radio signal in the K1 cells;
wherein the first DCI indicates a first symbol set, the first radio signal occupying the first symbol set in time domain; a first field set in the first DCI is applied to a target cell in the first cell set; an indication of the first field set in the first DCI depends on whether the target cell is configured with at least one first-type symbol, or the indication of the first field set in the first DCI depends on whether the first symbol set comprises at least one first-type symbol; the first-type symbol includes a symbol for uplink that is configured as downlink symbol by TDD UL-DL configuration signaling.
